(19) United States
(12) Patent Application Publication
(10) Pub. No.: US 2015/0361345 A1
(43) Pub. Date: Dec. 17, 2015

(54) LIQUID CRYSTAL ALIGNMENT AGENT, LIQUID CRYSTAL ALIGNMENT FILM, AND LIQUID CRYSTAL DISPLAY ELEMENT

(71) Applicant: Chi Mei Corporation, Tainan City (TW)

(72) Inventor: Shin-Rong Chiou, Kaohsiung City (TW)

(21) Appl. No.: 14/730,240

(22) Filed: Jun. 4, 2015

(30) Foreign Application Priority Data
Jun. 12, 2014 (TW) 103120353

(51) Int. Cl. C09K 19/56; C08J 5/18; G02F 1/1337; C08L 79/08

(52) U.S. Cl. CPC C09K 19/56; C08L 79/08; C08J 5/18; G02F 1/133719; C08J 2379/08; C08L 2203/16; C08L 2203/20

(57) ABSTRACT

The invention relates to a liquid crystal alignment agent, a liquid crystal alignment film, and a liquid crystal display element. The liquid crystal alignment agent contains: a polymer composition (A) prepared by reacting a mixture including a tetracarboxylic dianhydride component (a) and a diamine component (b), a photopolymerizable compound (B), and a solvent (C). The diamine component (b) includes at least one diamine compound (b-1) having the structure represented by formula (II):

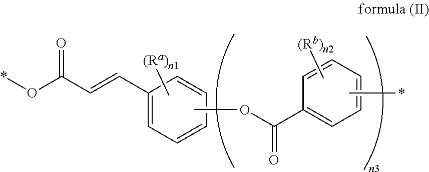

In the formula, R^{a} and R^{b} each independently represent a C₁ to C₆ alkyl group, a C₁ to C₆ alkoxy group, a halogen atom, or a cyano group; n1 and n2 each independently represent an integer of 0 to 4; n3 represents 0 or 1; and * each independently represents a connecting bond.

### CROSS-REFERENCE TO RELATED APPLICATION

This application claims the priority benefit of Taiwan application serial no. 103120353, filed on Jun. 12, 2014. The entirety of the above-mentioned patent application is hereby incorporated by reference herein and made a part of this specification.

### BACKGROUND OF THE INVENTION

1. Field of the Invention

The invention relates to a photoalignment-type liquid crystal alignment agent, a liquid crystal alignment film, and a liquid crystal display element. More particularly, the invention relates to a liquid crystal alignment agent that can be used to fabricate a liquid crystal display element having low ion density after ultraviolet irradiation and a liquid crystal alignment film formed thereby, and a liquid crystal display element having the liquid crystal alignment film.

2. Description of Related Art

The liquid crystal display is widely applied in, for instance, television and various monitors. An LCD display element having the following types of liquid crystal cell is known: twisted nematic (TN)-type, super-twisted nematic (STN)-type, in-plane switching (IPS)-type, and fringe field switching (FFS)-type changing the electrode structures of IPS-type and increasing brightness by increasing the aperture ratio of the display element component . . . etc.

The following is a known method for aligning liquid crystal of liquid crystal cells: an organic film such as a liquid crystal alignment film is formed on the surface of a substrate, and a cloth material such as rayon is used to rub the surface of the organic film in a certain direction; silicon oxide is deposited on the surface of the substrate diagonally via vapor deposition; and a Langmuir-Blodgett (LB) method is used to form a monomolecular film having a long-chain alkyl group. In particular, from the viewpoint of substrate size, uniformity of liquid crystal alignment, treatment time, and treatment costs, a rubbing treatment is most commonly used.

However, if liquid crystal alignment is performed by using a rubbing treatment, dust may be adhered to the surface of the alignment film due to dust or static electricity generated during the process, thus causing poor display. In particular, for a substrate having a thin film transistor (TFT) element, the generated static electricity causes damage to the circuit of the TFT element, thus causing reduced yield. Moreover, for the liquid crystal display element becoming increasingly highly delicate in the future, the surface of the substrate becomes uneven with high densification of the pixels, and therefore a uniform rubbing treatment is not readily performed.

As a result, to avoid such undesired situation, a photoalignment method (such as Japanese Patent Laid-Open 2005-037654) providing liquid crystal alignment capability by irradiating polarized or non-polarized radiation on a photosensitive thin film is known. The patent literature provides a repeating unit having conjugated enone and a liquid crystal alignment agent having an imide structure. Therefore, static electricity and dust are not generated, and therefore uniform liquid crystal alignment can be achieved. Moreover, in comparison to the rubbing treatment, the method can precisely control the direction of liquid crystal alignment in any direction. Furthermore, by using, for instance, a photomask when radiation is irradiated, a plurality of regions having different directions of liquid crystal alignment can be formed on one substrate in any manner.

However, the liquid crystal display element obtained from the liquid crystal alignment agent still has the issue of excessive ion density after ultraviolet irradiation, such that the display quality is poor and the liquid crystal display element does not meet the industry's standards.

### SUMMARY OF THE INVENTION

Accordingly, the invention provides a liquid crystal alignment agent, a liquid crystal alignment film using the liquid crystal alignment agent, and a liquid crystal display element capable of solving the issue of excessive ion density of the liquid crystal display element made from the liquid crystal alignment agent after ultraviolet irradiation.

The invention provides a liquid crystal alignment agent including a polymer composition (A), a photopolymerizable compound (B), and a solvent (C), wherein the polymer composition (A) is obtained by reacting a mixture including a tetracarboxylic dianhydride component (a) and a diamine component (b), and the photopolymerizable compound (B) is as shown in formula (1):

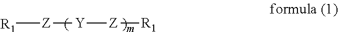

In formula (1), R₁ independently represents a polymerizable functional group represented by formula (1-1) to formula (1-5), a hydrogen atom, a halogen atom, —CN, —CF₃, —CF₂H, —CFH₂, —OCF₃, —OCF₂H, —N═C═O, —N═C—S, or a C₁ to C₂₀ alkyl group, wherein any —CH₂— in the alkyl group can be substituted by —O—, —S—, —SO₂—, —CO—, —COO—, —OCO—, —CH═CH—, —CF═CF—, or —C≡C—, and in the hydrogen atom-containing functional group, a hydrogen atom can be substituted by a halogen atom or —CN; at least one R₁ is a polymerizable functional group represented by formula (1-1) to formula (1-5); Y independently represents a divalent group of a C₃ to C₂₁ saturated or unsaturated independent ring, condensed ring, or Spiro ring, wherein in the ring, any —CH₂— can be substituted by —O—, any —CH═ can be substituted by —N═, any —H can be substituted by a halogen atom, —CN, —NO₂, —NC, —N═C═O, —N═C—S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group, and in the alkyl group, any —CH₂— can be substituted by —O—, —CO—, —COO—, —OCO—, —OCOO—, —CH═CH—, or —C≡C—; Z independently represents a single bond or a C₁ to C₂₀ alkylene group, wherein in the alkylene group, any —CH₂— can be substituted by —O—, —S—, —SO₂—, —CO—, —COO—, —OCO—, —OCOO—, —CH═CH—, —CF═CF—, —CH═N—, —N═CH—, —N═N—, —N(O)═N—, or —C≡C—, and any —H can be substituted by a halogen atom, a C₁ to C₁₀ alkyl group, or a C₁ to C₁₀ haloalkyl group; m represents an integer of 1 to 6, and when m is an integer of 2 to 6, a plurality of —Y—Z— can be the same or different;

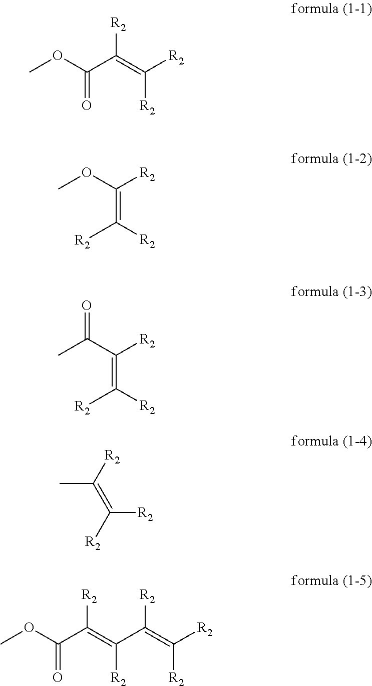

In formula (1-1) to formula (1-5), R₂ represents a hydrogen atom, a halogen atom, —CF₃, or a C₁ to C₅ alkyl group, and the diamine component (b) includes at least one diamine compound (b-1) having the structure represented by formula (II).

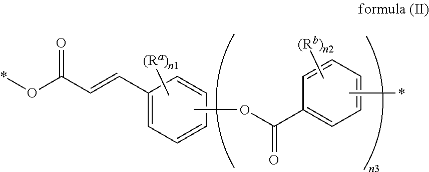

In formula (II), R^{a} and R^{b} each independently represent a C₁ to C₆ alkyl group, a C₁ to C₆ alkoxy group, a halogen atom, or a cyano group; n1 and n2 each independently represent an integer of 0 to 4; n3 represents 0 or 1; and * each independently represents a connecting bond.

In an embodiment of the invention, at least one R₁ is a polymerizable functional group represented by formula (1-1) to formula (1-3).

In an embodiment of the invention, Y each independently represents a divalent group of 1,4-cyclohexylene, 1,4-cyclohexenylene, 1,4-phenylene, naphthalene-2,6-diyl, tetrahydronaphthalene-2,6-diyl, fluorene-2,7-diyl, bicyclo[2.2.2]octane-1,4-diyl, bicyclo[3.1.0]hexane-3,6-diyl, or triptycene-1,4-diyl, wherein in the ring, any —CH₂— can be substituted by —O—, any —CH═ can be substituted by —N═, any —H can be substituted by a halogen atom, —CN, —NO₂, —NC, —N═C═O, —N═C—S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group, and in the alkyl group, any —CH₂— can be substituted by —O—, —CO—, —COO—, —OCO—, —OCOO—, —CH═CH—, or —C≡C—.

In an embodiment of the invention, Y is at least one group selected from the group consisting of functional groups represented by formula (1-6) to formula (1-30):

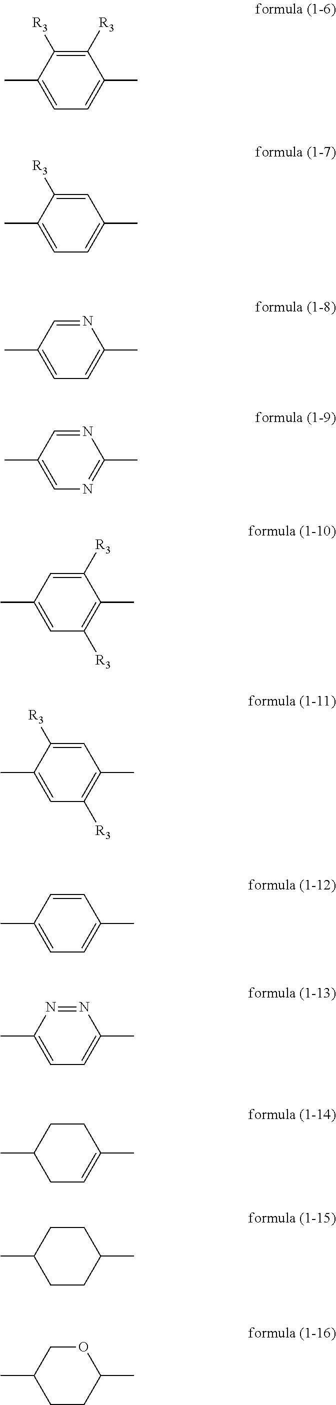

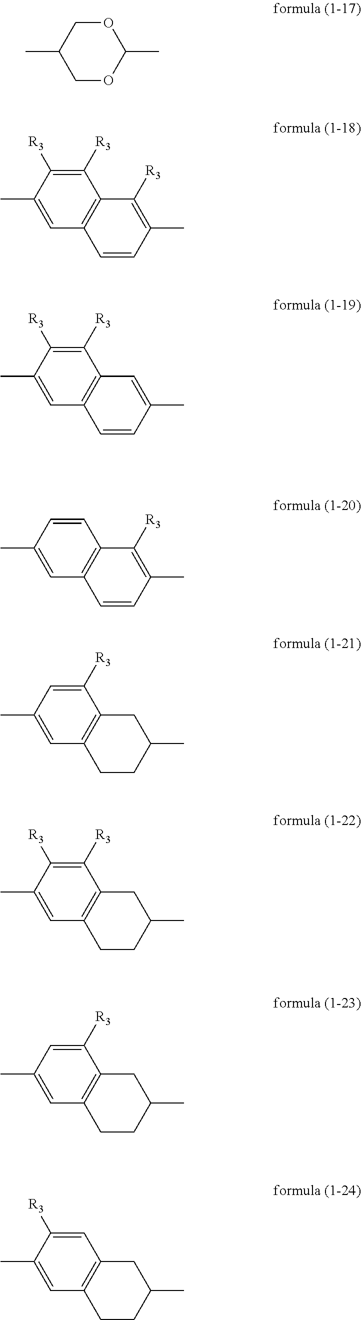

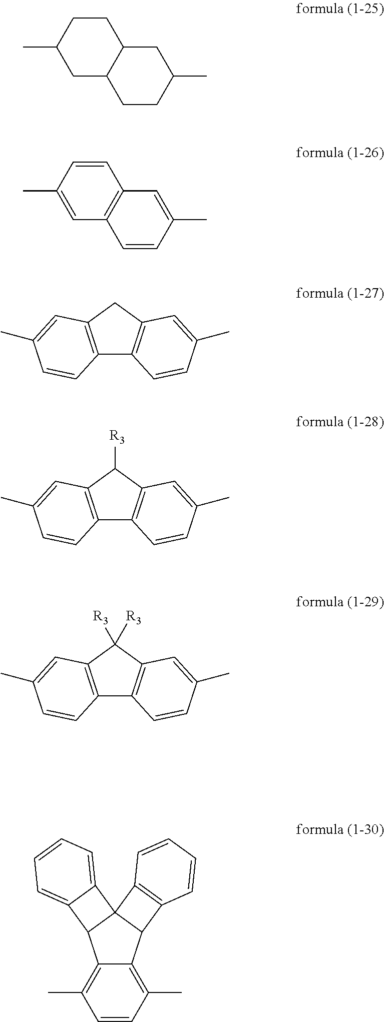

In formula (1-6) to formula (1-30), R₃ represents a halogen atom, a C₁ to C₃ alkyl group, a C₁ to C₃ alkoxy group, or a C₁ to C₃ haloalkyl group.

In an embodiment of the invention, the photopolymerizable compound (B) is at least one compound selected from the group consisting of compounds represented by formula (1-31) to formula (1-42):

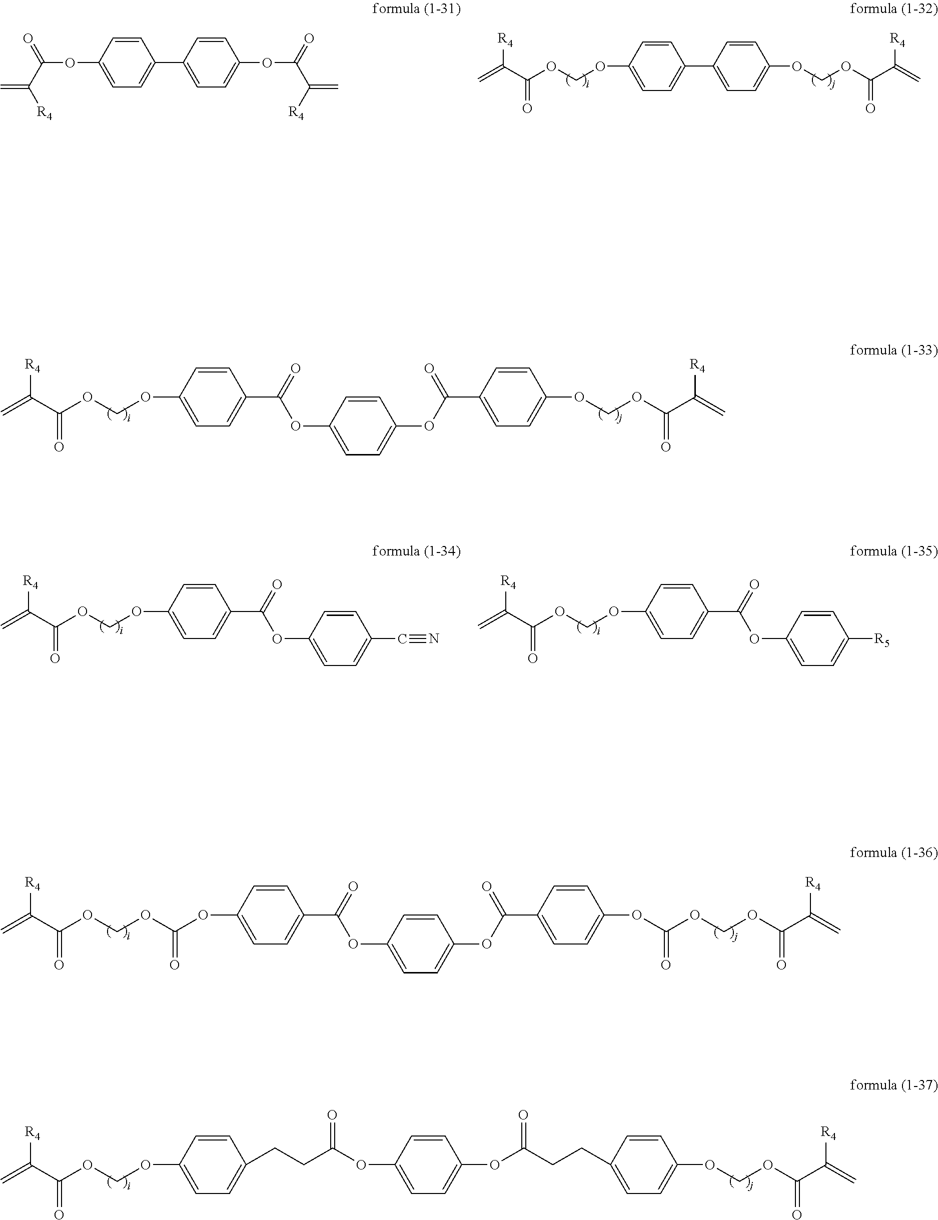

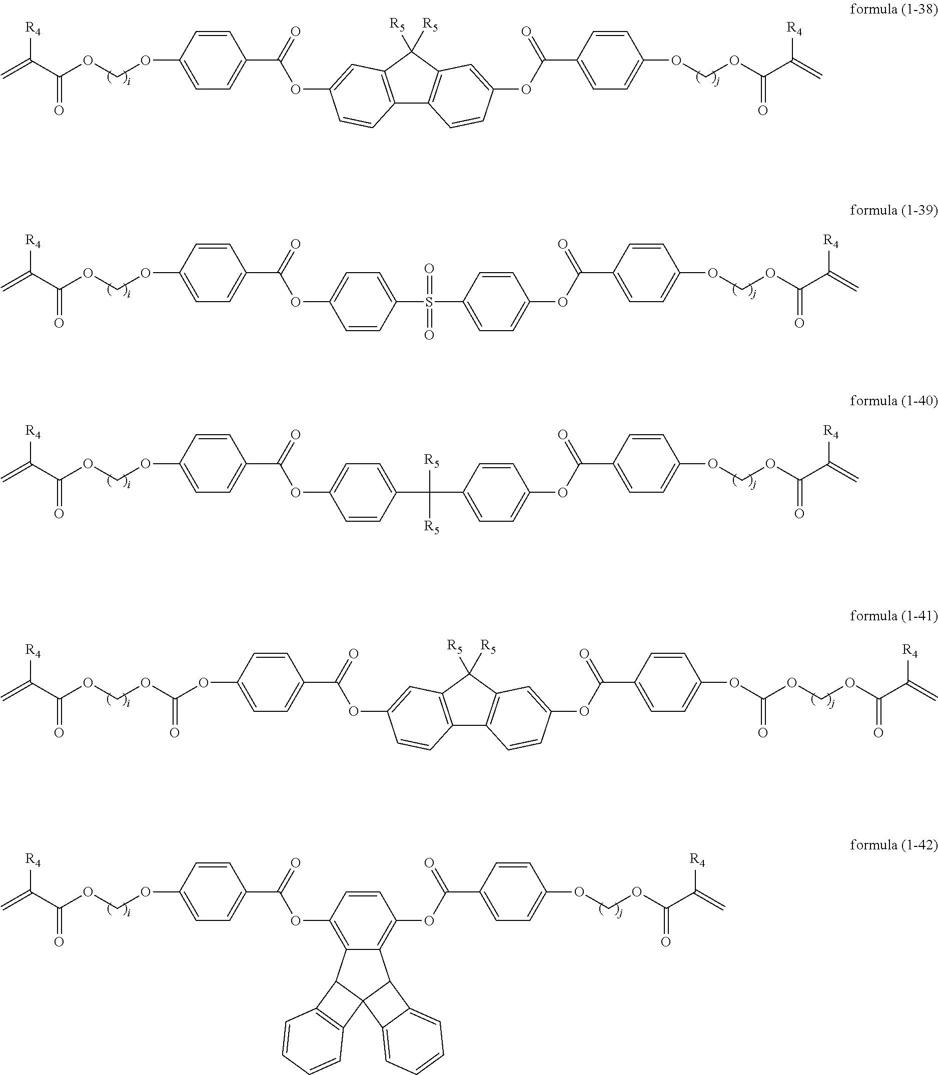

In formula (1-31) to formula (1-42), R₄ independently represents a hydrogen atom or a methyl group; R₅ independently represents a hydrogen atom, a halogen atom, a methyl group, —CF₃, —OCH₃, or a phenyl group, and 2 R₅ on the same carbon atom can form a C₆ to C₁₅ saturated or unsaturated hydrocarbon ring; and i and j independently represent an integer of 1 to 20.

In an embodiment of the invention, the diamine compound (b-1) has at least one structure selected from the group consisting of a structure represented by formula (II-1) and a structure represented by formula (II-2).

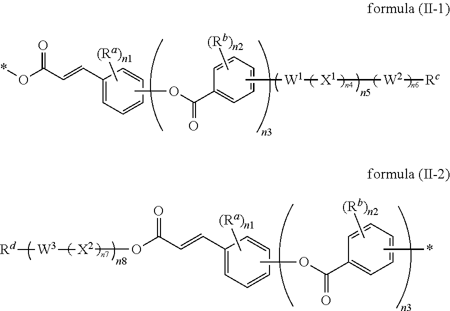

In formula (II-1) and formula (II-2), R^{a} and R^{b} each independently represent a C₁ to C₆ alkyl group, a C₁ to C₆ alkoxy group, a halogen atom, or a cyano group; R^{c} and R^{d} each independently represent a C₁ to C₄₀ alkyl group or a fluorine atom-substituted C₁ to C₄₀ alkyl group; W¹, W², and W³ each independently represent —O—, —CO—, —CO—O—, —O—CO—, —NR^{e}—, —NR^{e}—CO—, —CO—NR^{e}—, —NR^{e}—CO—O—, —O—CO—NR^{e}—, —NR^{e}—CO—NR^{e}—, or —O—CO—O—, wherein R^{e} represents a hydrogen atom or a C₁ to C₄ alkyl group; X¹ and X² each independently represent a methylene group, an arylene group, a divalent alicyclic group, —Si(CH₃)₂—, —CH═CH—, —C≡C—, a methylene group having a substituent, an arylene group having a substituent, a divalent alicyclic group having a substituent, —Si(CH₃)₂— having a substituent, or —CH═CH— having a substituent, wherein the substituent is a cyano group, a halogen atom, or a C₁ to C₄ alkyl group; n1 and n2 each independently represent an integer of 0 to 4; n3 represents 0 or 1; n4 and n7 each independently represent an integer of 1 to 6; n5 and n8 each independently represent an integer of 0 to 2; n6 represents 0 or 1; and * each independently represents a connecting bond.

In an embodiment of the invention, based on a total usage amount of 100 moles of the diamine component (b), the usage amount of the diamine compound (b-1) is 10 moles to 80 moles.

In an embodiment of the invention, based on a usage amount of 100 parts by weight of the polymer composition (A), the usage amount of the photopolymerizable compound (B) is 5 parts by weight to 30 parts by weight.

The invention further provides a liquid crystal alignment film. The liquid crystal alignment film is formed by the above liquid crystal alignment agent.

The invention further provides a liquid crystal display element. The liquid crystal display element includes the above liquid crystal alignment film.

Based on the above, since the liquid crystal alignment agent of the invention contains a specific diamine compound and photopolymerizable compound, by using the liquid crystal display element made from the liquid crystal alignment agent, the known issue of excessive ion density after ultraviolet irradiation can be alleviated. As a result, the liquid crystal alignment agent of the invention is suitable for a liquid crystal alignment film and a liquid crystal display element.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a liquid crystal display element according to an embodiment of the invention.

### DESCRIPTION OF THE EMBODIMENTS

A liquid crystal alignment agent of the invention contains a polymer composition (A), a photopolymerizable compound (B), and a solvent (C). The invention is not limited thereto, and without affecting the efficacy of the invention, the liquid crystal alignment agent of the invention can also contain an additive (D). In the following, each component in the liquid crystal alignment agent is described in detail.

### [Polymer Composition (A)]

The polymer composition (A) of the invention is obtained by reacting a mixture including a tetracarboxylic dianhydride component (a) and a diamine component (b).

Specifically, the polymer composition (A) includes a polyamic acid polymer, a polyimide polymer, a polyamic acid-polyimide block copolymer, or a combination of the polymers. In particular, a polyimide-based block copolymer includes a polyamic acid block copolymer, a polyimide block copolymer, a polyamic acid-polyimide block copolymer, or a combination of the polymers. The polyamic acid polymer, the polyimide polymer, and the polyamic acid-polyimide block copolymer can all be obtained by reacting a mixture of the tetracarboxylic dianhydride component (a) and the diamine component (b).

<Tetracarboxylic Dianhydride Component (a)>

The tetracarboxylic dianhydride component (a) is at least one compound selected from the group consisting of an aliphatic tetracarboxylic dianhydride compound, an alicyclic tetracarboxylic dianhydride compound, an aromatic tetracarboxylic dianhydride compound, and tetracarboxylic dianhydride compounds represented by formula (I-1) to formula (I-6).

Specific examples of the aliphatic tetracarboxylic dianhydride compound, the alicyclic tetracarboxylic dianhydride compound, and the aromatic tetracarboxylic dianhydride compound are listed below. However, the invention is not limited to the specific examples.

Specific examples of the aliphatic tetracarboxylic dianhydride compound can include, for instance: ethane tetracarboxylic dianhydride or butane tetracarboxylic dianhydride.

Specific examples of the alicyclic tetracarboxylic dianhydride compound can include, for instance: 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dichloro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyl tetracarboxylic dianhydride, cis-3,7-dibutyl-cycloheptyl-1,5-diene-1,2,5,6-tetracarboxylic dianhydride, 2,3,5-tricarboxycyclopentylacetic dianhydride, or bicyclo[2.2.2]-oct-7-ene-2,3,5,6-tetracarboxylic dianhydride.

Specific examples of the aromatic tetracarboxylic acid dianhydride compound can include, for instance, 3,4-dicarboxy-1,2,3,4-tetrahydronaphthalene-1-succinic dianhydride, pyromellitic dianhydride, 2,2′,3,3′-benzophenone tetracarboxylic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′-4,4′-diphenyl ethane tetracarboxylic dianhydride, 3,3′,4,4′-dimethyl diphenyl silane tetracarboxylic dianhydride, 3,3′,4,4′-tetraphenyl silane tetracarboxylic dianhydride, 2,3,4-furan tetracarboxylic dianhydride, 2,3,3′,4′-diphenyl ether tetracarboxylic dianhydride, 3,3′,4,4′-diphenyl ether tetracarboxylic dianhydride, 4,4′-bis(3,4-dicarboxyphenoxy)diphenylsulfide dianhydride, 2,3,3′,4′-diphenyl sulfide tetracarboxylic dianhydride, 3,3′,4,4′-diphenyl sulfide tetracarboxylic dianhydride, 4,4′-bis(3,4-dicarboxyphenoxy)diphenyl sulfone dianhydride, 4,4′-bis(3,4-dicarboxyphenoxy)diphenyl propane dianhydride, 3,3′,4,4′-perfluoroisopropylidene diphthalic acid dianhydride, 2,2′,3,3′-diphenyl tetracarboxylic dianhydride, 2,3,3′,4′-diphenyl tetracarboxylic dianhydride, 3,3′,4,4′-diphenyl tetracarboxylic dianhydride, bis(phthalic acid)phenyl phosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl) propane-bis(anhydrotrimellitate), 2,3,4,5-tetrahydrofuran tetracarboxylic dianhydride, 1,3,3a,4,5,9b-hexahydro-5-(tetrahydro-2,5-dioxo-3-furanyl)naphtho[1,2-c]furan-1,3-dione, 1,3,3a,4,5,9b-hexahydro-5-methyl-5-(tetrahydro-2,5-dioxo-3-furanyl)naphtho[1,2-c]furan-1,3-dione, 1,3,3a,4,5,9b-hexahydro-5-ethyl-5-(tetrahydro-2,5-dioxo-3-furanyl)naphtho[1,2-c]furan-1,3-dione, 1,3,3a,4,5,9b-hexahydro-7-methyl-5-(tetrahydro-2,5-dioxo-3-furanyl)naphtho[1,2-c]furan-1,3-dione, 1,3,3a,4,5,9b-hexahydro-7-ethyl-5-(tetrahydro-2,5-dioxo-3-furanyl)naphtho[1,2-c]furan-1,3-dione, 1,3,3a,4,5,9b-hexahydro-8-methyl-5-(tetrahydro-2,5-dioxo-3-furanyl)naphtho[1,2-c]furan-1,3-dione, 1,3,3a,4,5,9b-hexahydro-8-ethyl-5-(tetrahydro-2,5-dioxo-3-furanyl) naphtho[1,2-c]furan-1,3-dione, 1,3,3a,4,5,9b-hexahydro-5,8-dimethyl-5-(tetrahydro-2,5-dioxo-3-furanyl)naphtho[1,2-c]furan-1,3-dione, or 5-(2,5-dioxotetrahydrofuranyl)-3-methyl-3-cyclohexene-1,2-dicarboxylic dianhydride.

The tetracarboxylic dianhydride compounds represented by formula (I-1) to formula (I-6) are as shown below.

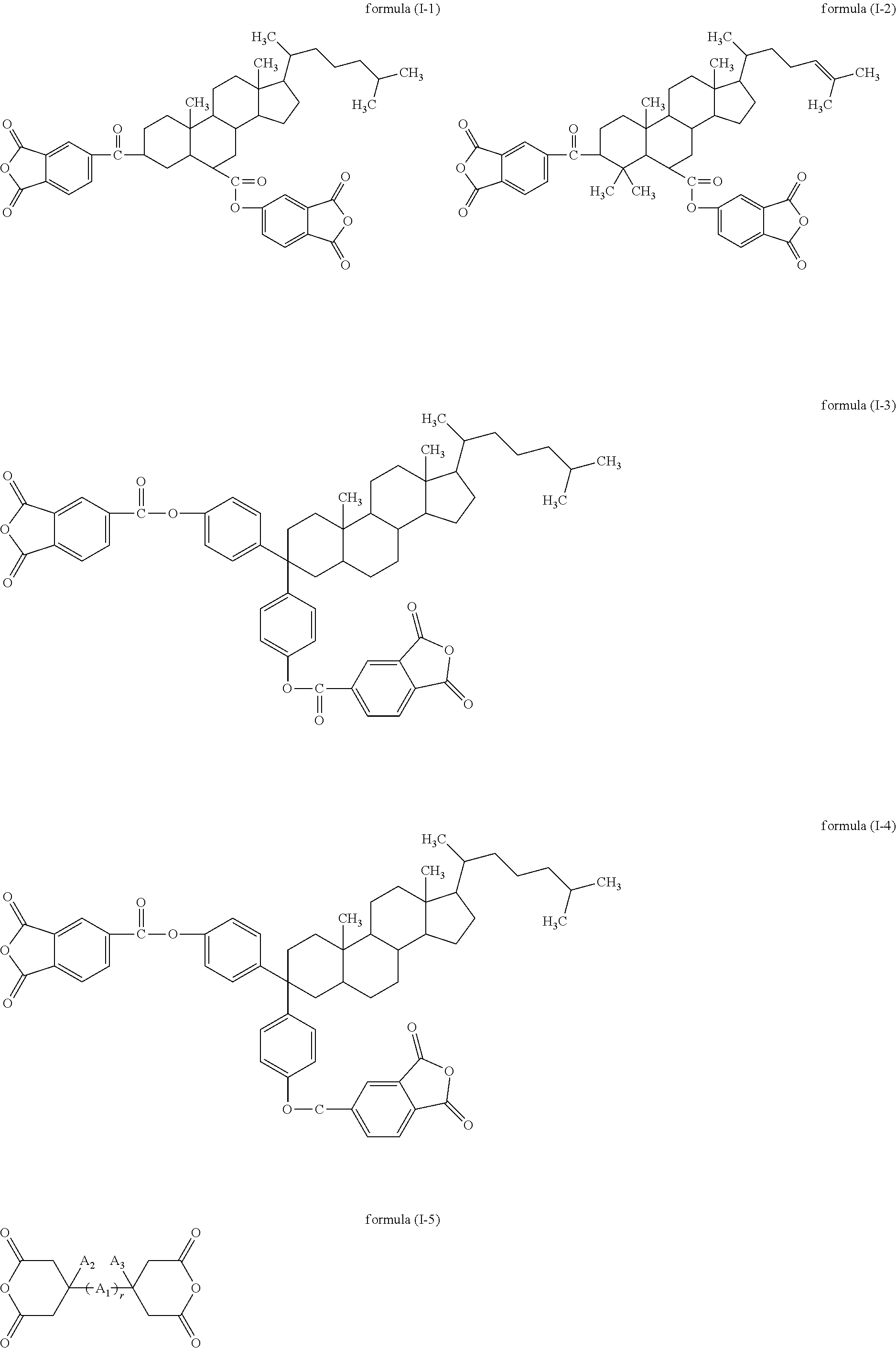

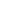

In formula (I-5), A₁ represents a divalent group containing an aromatic ring; r represents an integer of 1 to 2; and A₂ and A₃ can be the same or different, and can each independently represent a hydrogen atom or an alkyl group. The tetracarboxylic dianhydride compound represented by formula (I-5) is preferably a compound represented by formula (I-5-1) to formula (I-5-3).

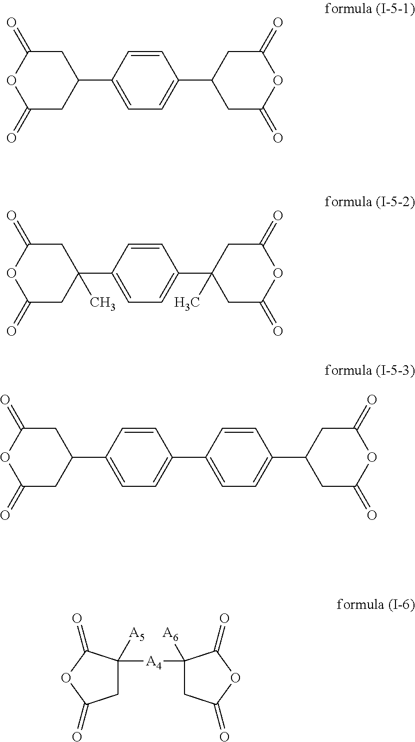

In formula (I-6), A₄ represents a divalent group containing an aromatic ring; and A₅ and A₆ can be the same or different, and each independently represent a hydrogen atom or an alkyl group. The tetracarboxylic dianhydride compound represented by formula (I-6) is preferably a compound represented by formula (I-6-1).

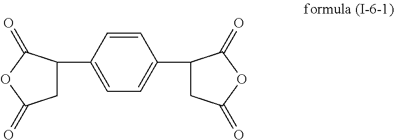 [SMILES: O=C1CC(c2ccc(C3CC(=O)OC3=O)cc2)C(=O)O1]

The tetracarboxylic dianhydride component (a) is preferably at least one compound selected from the group consisting of 1,2,3,4-cyclobutane tetracarboxylic dianhydride, 1,2,3,4-cyclopentane tetracarboxylic dianhydride, 2,3,5-tricarboxycyclopentylacetic dianhydride, 1,2,4,5-cyclohexane tetracarboxylic dianhydride, 3,4-dicarboxy-1,2,3,4-tetrahydronaphthalene-1-succinic dianhydride, pyromellitic dianhydride, 3,3′,4,4′-benzophenone tetracarboxylic dianhydride, and 3,3′,4,4′-diphenylsulfone tetracarboxylic dianhydride.

Based on a total number of moles of 100 moles of the diamine component (b), the usage amount of the tetracarboxylic dianhydride component (a) preferably ranges from 20 moles to 200 moles; and the usage amount of the tetracarboxylic dianhydride component (a) more preferably ranges from 30 moles to 120 moles.

<Diamine Component (b)>

The diamine component (b) includes at least one diamine compound (b-1) having the structure represented by formula (II). However, the invention is not limited thereto, and the diamine component (b) can also include other diamine compounds (b-2).

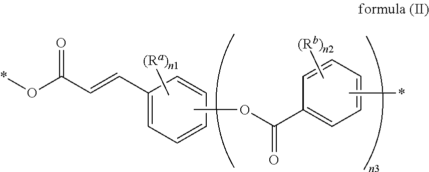

In formula (II), R^{a} and R^{b} each independently represent a C₁ to C₆ alkyl group, a C₁ to C₆ alkoxy group, a halogen atom, or a cyano group; n1 and n2 each independently represent an integer of 0 to 4; n3 represents 0 or 1; and * each independently represents a connecting bond.

The diamine compound (b-1) preferably has at least one structure selected from the group consisting of a structure represented by formula (II-1) and a structure represented by formula (II-2);

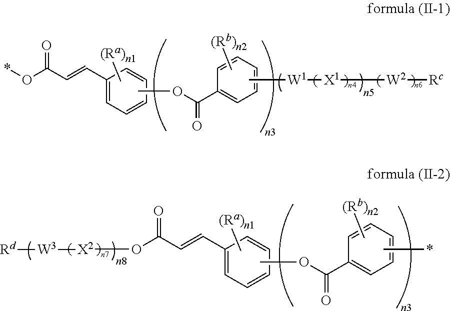

In formula (II-1) and formula (II-2), R^{a} and R^{b} each independently represent a C₁ to C₆ alkyl group, a C₁ to C₆ alkoxy group, a halogen atom, or a cyano group; R^{c} and R^{d} each independently represent a C₁ to C₄₀ alkyl group or a fluorine atom-substituted C₁ to C₄₀ alkyl group; W¹, W², and W³ each independently represent —O—, —CO—, —CO—O—, —O—CO—, —NR^{e}—, —NR^{e}—CO—, —CO—NR^{e}—, —NR^{e}—CO—O—, —O—CO—NR^{e}—, —NR^{e}—CO—NR^{e}—, or —O—CO—O—, wherein R^{e} represents a hydrogen atom or a C₁ to C₄ alkyl group; X¹ and X² each independently represent a methylene group, an arylene group, a divalent alicyclic group, —Si(CH₃)₂—, —CH═CH—, —C≡C—, a methylene group having a substituent, an arylene group having a substituent, a divalent alicyclic group having a substituent, —Si(CH₃)₂— having a substituent, or —CH═CH— having a substituent, wherein the substituent is a cyano group, a halogen atom, or a C₁ to C₄ alkyl group; n1 and n2 each independently represent an integer of 0 to 4; n3 represents 0 or 1; n4 and n7 each independently represent an integer of 1 to 6; n5 and n8 each independently represent an integer of 0 to 2; n6 represents 0 or 1; and * each independently represents a connecting bond.

In formula (II-1) and formula (II-2), specific examples of the C₁ to C₄₀ alkyl group can include, for instance: n-pentyl, n-hexyl, n-heptyl, n-octyl, n-nonyl, n-decyl, n-lauryl, n-dodecyl, n-tridecyl, n-tetradecyl, n-pentadecyl, n-hexadecyl, n-heptadecyl, n-octadecyl, n-nonadecyl, or n-eicosyl, and specific examples of the fluorine atom-substituted C₁ to C₄₀ alkyl group can include, for instance: 4,4,4-trifluorobutyl, 4,4,5,5,5-pentafluoropentyl, 4,4,5,5,6,6,6-heptafluorohexyl, 3,3,4,4,5,5,5-heptafluoropentyl, 2,2,2-trifluoroethyl, 2,2,3,3,3-pentafluoropropyl, 2-(perfluorobutyl)ethyl, 2-(perfluorooctyl)ethyl, or 2-(perfluorodecyl)ethyl.

The fluorine atom-substituted C₁ to C₄₀ alkyl group is a C₁ to C₄₀ alkyl group in which a portion or all of the hydrogen atoms are substituted by fluorine atoms. Preferably, the fluorine atom-substituted C₁ to C₄₀ alkyl group is a C₁ to C₂₀ alkyl group in which a portion or all of the hydrogen atoms are substituted by fluorine atoms.

The fluorine atom-substituted C₁ to C₄₀ alkyl group is preferably a straight-chain or branched-chain C₁ to C₁₆ fluoroalkyl group. Moreover, from the viewpoint of exhibiting good liquid crystal alignment, the fluorine atom-substituted C₁ to C₄₀ alkyl group is preferably a C₁ to C₈ straight-chain fluoroalkyl group. The fluorine atom-substituted C₁ to C₄₀ alkyl group is more preferably a C₃ to C₆ straight-chain fluoroalkyl group such as 2,2,2-trifluoroethyl, 3,3,3-trifluoro-n-propyl, 4,4,4-trifluoro-n-butyl, 4,4,5,5,5-pentafluoro-n-pentyl, or 4,4,5,5,6,6,6-heptafluorohexyl, preferably 2,2,2-trifluoroethyl, 3,3,3-trifluoro-n-propyl, 4,4,4-trifluoro-n-butyl, or 4,4,5,5,5-pentafluoro-n-pentyl.

Specific examples of the diamine compound (b-1) having the structure represented by formula (II-1) include compounds represented by formula (II-1-1) to formula (II-1-25).

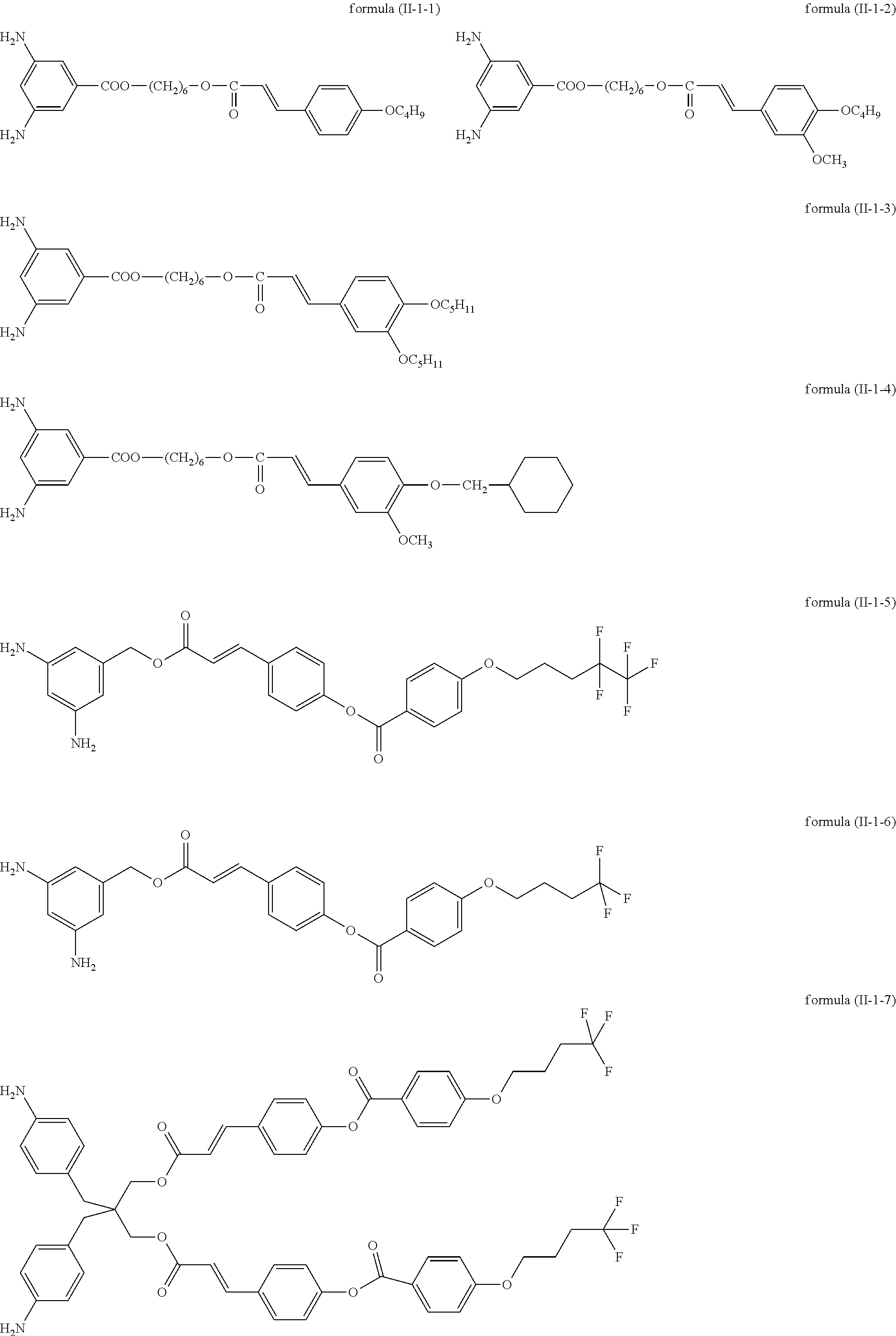

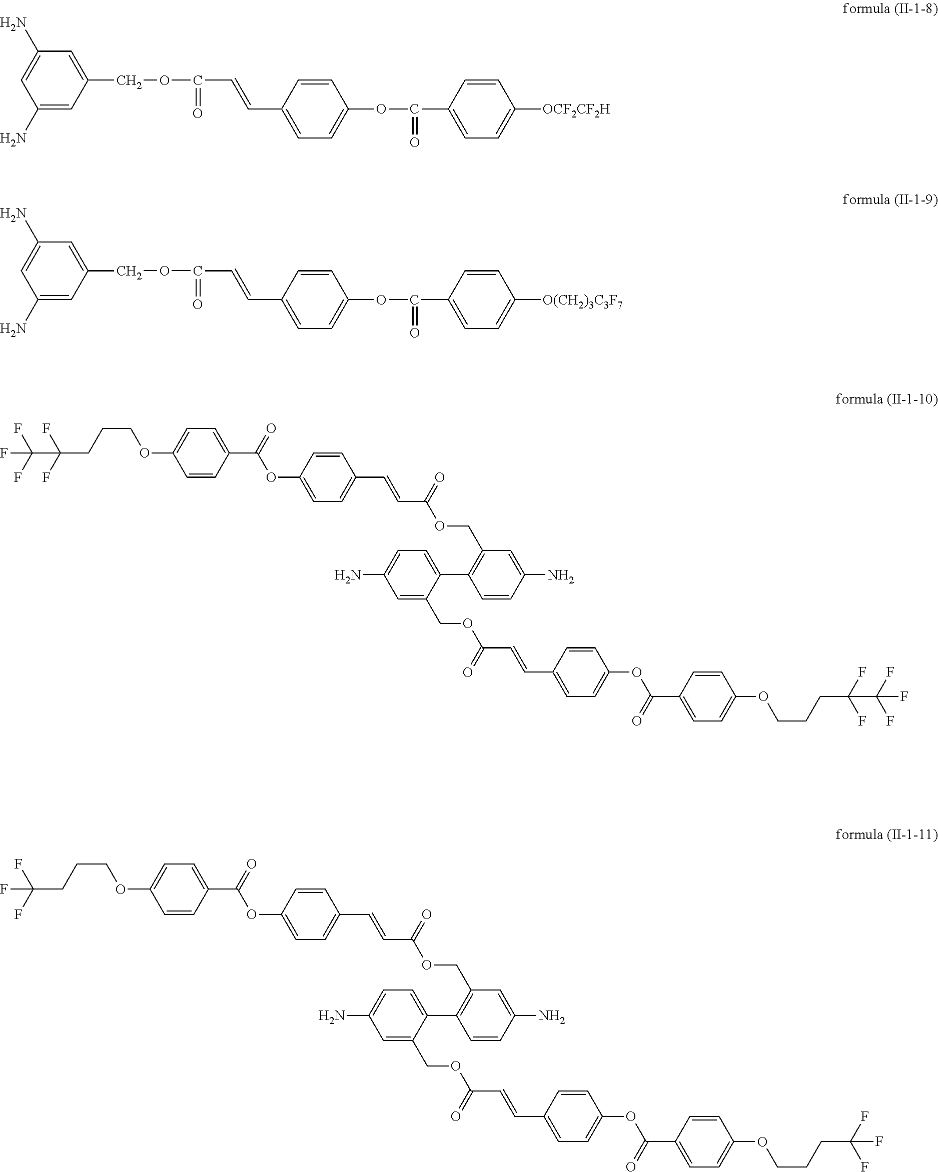

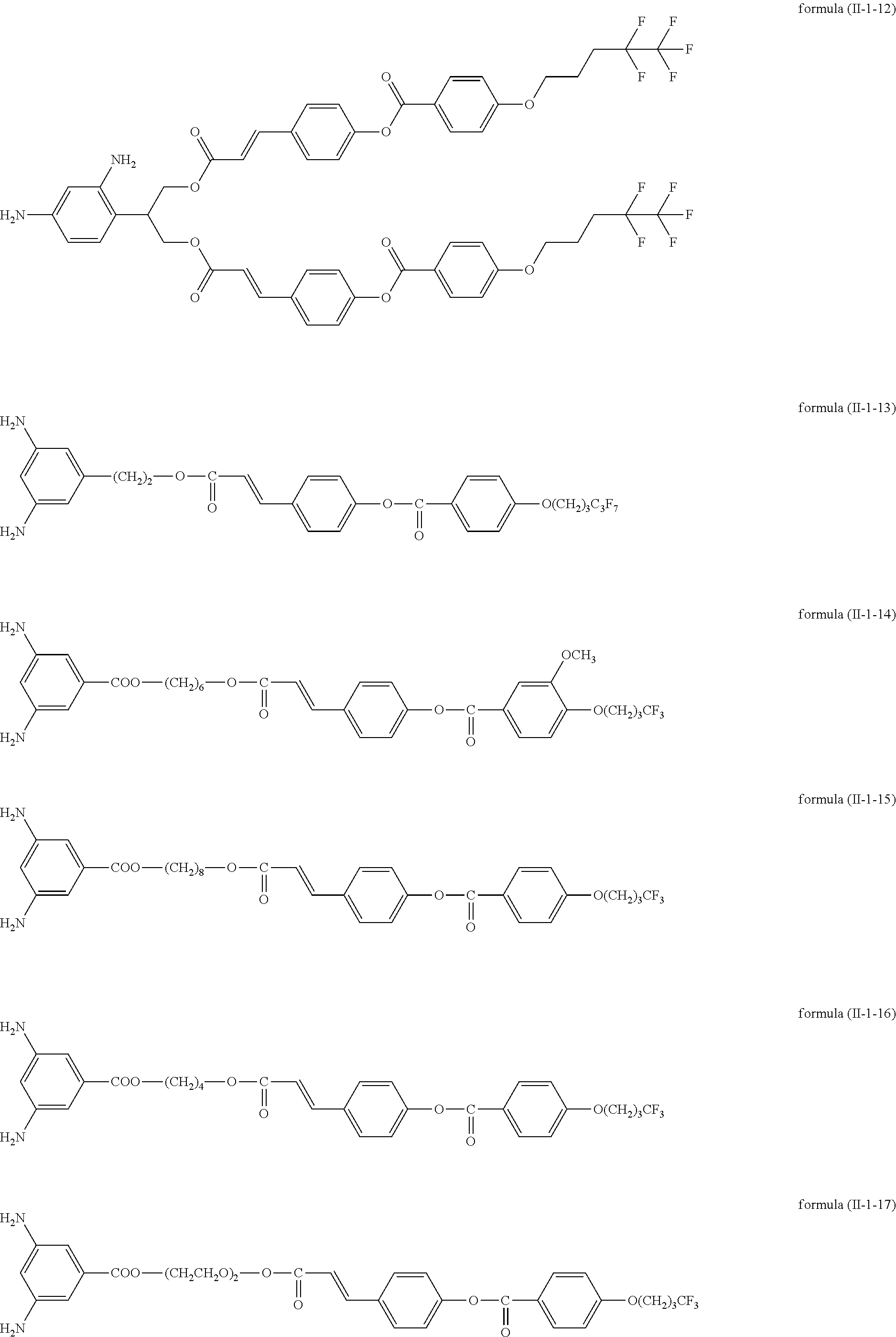

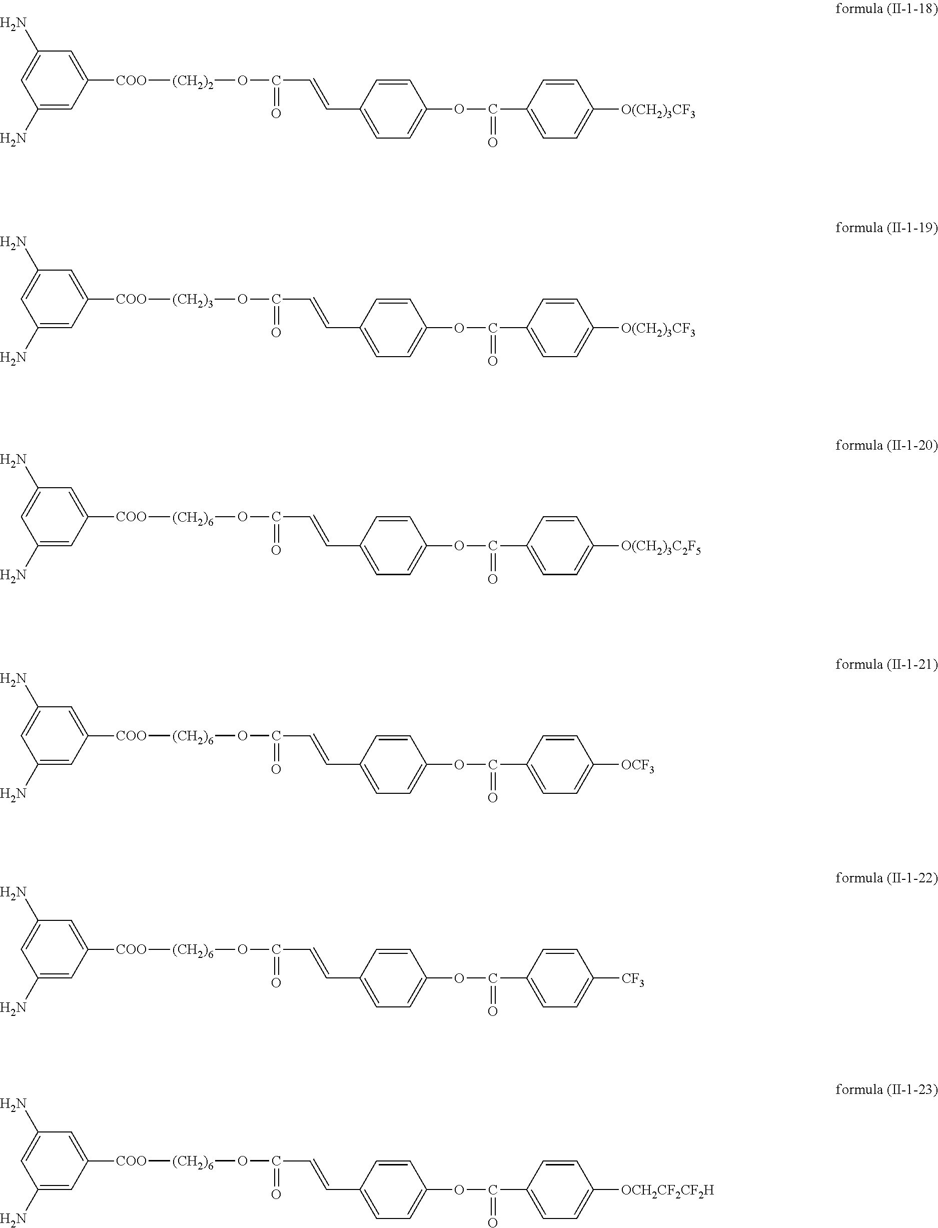

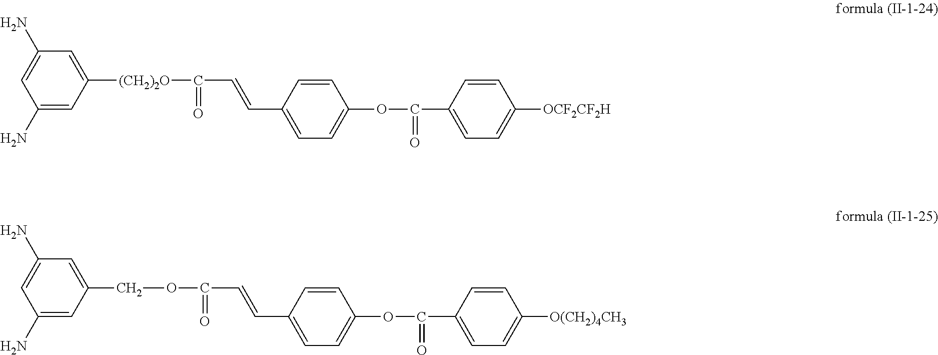

Specific examples of the diamine compound (b-1) having the structure represented by formula (II-2) include compounds represented by formula (II-2-1) to formula (II-2-2).

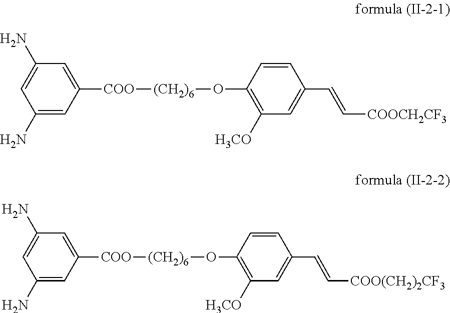

The diamine compound (b-1) is preferably at least one compound selected from the group consisting of diamine compounds represented by formula (II-1-3), formula (II-1-6), formula (II-1-7), and formula (II-2-1).

Based on a total usage amount of 100 moles of the diamine component (b), the usage amount of the diamine compound (b-1) is 10 moles to 80 moles, preferably 15 moles to 70 moles, and more preferably 20 moles to 60 moles.

If the diamine compound (b-1) is not used in the liquid crystal alignment agent, then the liquid crystal display element fabricated by using the liquid crystal alignment agent still has the issue of excessive ion density after ultraviolet irradiation.

The other diamine compounds (b-2) can include 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4′-diaminodicyclohexylmethane, 4,4′-diamino-3,3′-dimethyldicyclohexylamine, 1,3-diaminocyclohexane, 1,4-diaminocyclohexane, isophorone diamine, tetrahydrodicyclopentadiene diamine, tricyclo(6,2,1,0^{2,7})-undecenedimethyldiamine, 4,4′-methylenebis(cyclohexylamine), 4,4′-diaminodiphenylmethane, 4,4′-diaminodiphenylethane, 4,4′-diamino diphenylsulfone, 4,4′-diaminobenzoylaniline, 4,4′-diaminodiphenyl ether, 3,4′-diaminodiphenyl ether, 1,5-diaminonaphthalene, 5-amino-1-(4′-aminophenyl)-1,3,3-trimethyl indane, 6-amino-1-(4′-aminophenyl)-1,3,3-trimethyl indane, hexahydro-4,7-methanoindanylenedimethylenediamine, 3,3′-diamino benzophenone, 3,4′-diamino benzophenone, 4,4′-diamino benzophenone, 2,2-bis[4-(4-aminophenoxyl)phenyl]propane, 2,2-bis[4-(4-aminophenoxyl)phenyl]hexafluoropropane, 2,2-bis(4-aminophenyl)hexafluoropropane, 2,2-bis[4-(4-aminophenoxyl)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl) fluorene, 4,4′-methylene-bis(2-chloroaniline), 4,4′-(p-phenylene isopropylidene)bisaniline, 4,4′-(m-phenylene isopropylidene)bisaniline, 2,2′-bis[4-(4-amino-2-trifluoromethyl phenoxy)phenyl]hexafluoropropane, 4,4′-bis[(4-amino-2-trifluoromethyl)phenoxy]-octafluorobiphenyl, 5-[4-(4-n-pentylcyclohexyl)cyclohexyl]phenylmethylene-1,3-diaminobenzene, 1,1-bis[4-(4-aminophenoxyl)phenyl]-4-(4-ethylphenyl)cyclohexane, or diamine compounds represented by formula (IV-1) to formula (IV-30):

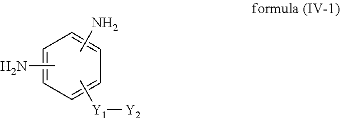

In formula (IV-1), Y₁ represents

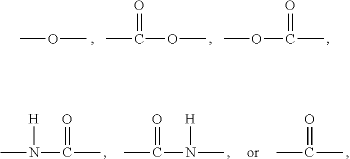

and Y² represents a steroid-containing group, a trifluoromethyl group, a fluorine group, a C₂ to C₃₀ alkyl group, or a monovalent group of a nitrogen atom-containing cyclic structure derived from, for instance, pyridine, pyrimidine, triazine, piperidine, or piperazine.

The diamine compound represented by formula (IV-1) is preferably 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene, or diamine compounds represented by formula (IV-1-1) to formula (IV-1-6) below:

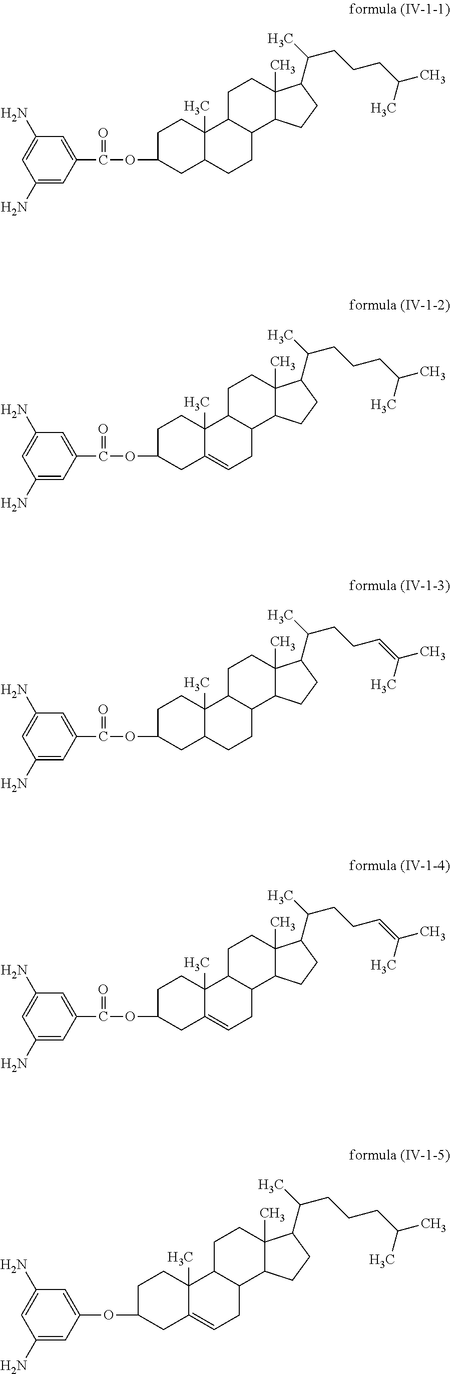

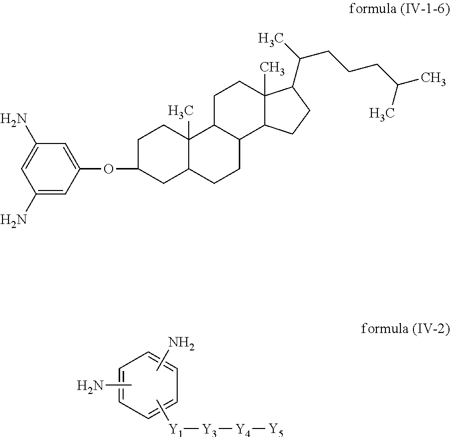

In formula (IV-2), Y₁ is the same as the Y₁ in formula (IV-1), Y₃ and Y₄ represent a divalent aliphatic ring, a divalent aromatic ring, or a divalent heterocyclic group, and Y₅ represents a C₃ to C₁₈ alkyl group, a C₃ to C₁₈ alkoxy group, a C₁ to C₅ fluoroalkyl group, a C₁ to C₅ fluoroalkyloxy group, a cyano group, or a halogen atom.

The diamine compound represented by formula (IV-2) is preferably a diamine compound represented by formula (IV-2-1) to formula (IV-2-13):

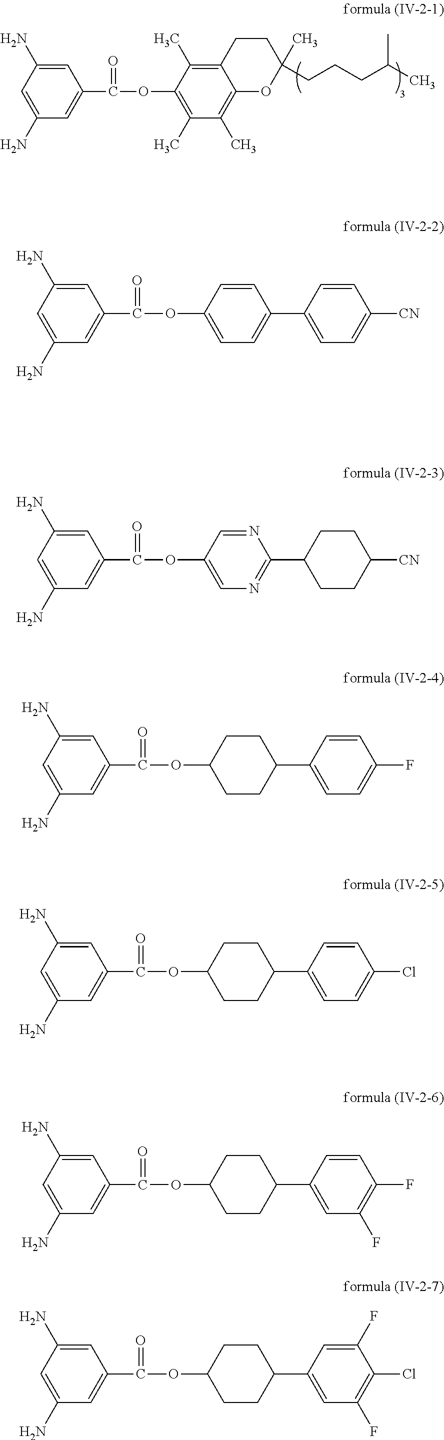

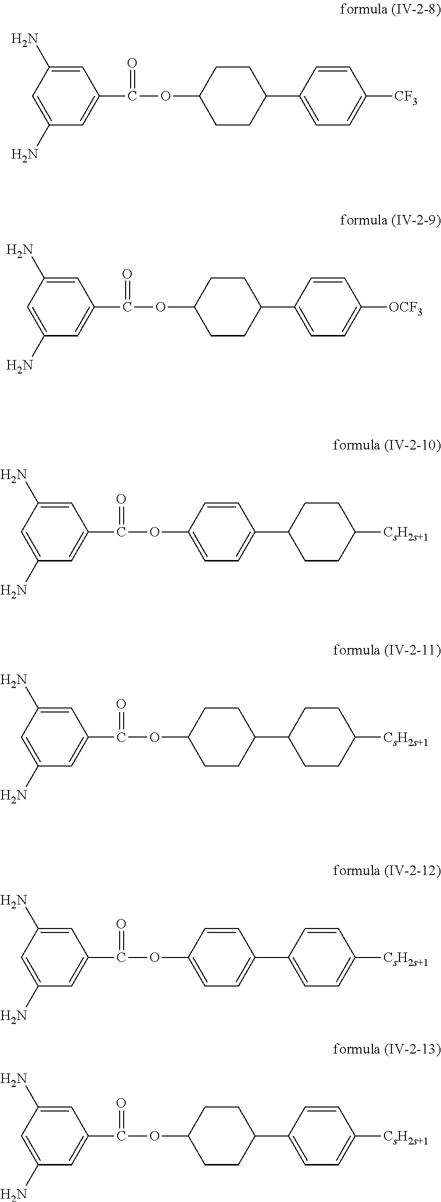

In formula (IV-2-10) to formula (IV-2-13), s represents an integer of 3 to 12.

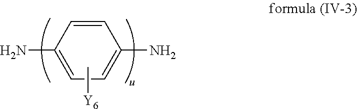

In formula (IV-3), Y₆ represents a hydrogen atom, a C₁ to C₅ acyl group, a C₁ to C₅ alkyl group, a C₁ to C₅ alkoxy group, or a halogen atom, and Y₆ in each repeating unit can be the same or different; and u represents an integer of 1 to 3.

The diamine compound represented by formula (IV-3) is preferably selected from: (1) when u is 1: p-diaminobenzene, m-diaminobenzene, o-diaminobenzene, or 2,5-diaminotoluene . . . etc.; (2) when u is 2: 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or 4,4′-diamino-2,2′-bis(trifluoromethyl) biphenyl . . . etc.; and (3) when u is 3: 1,4-bis(4′-aminophenyl)benzene . . . etc. In particular, p-diaminobenzene, 2,5-diaminotoluene, 4,4′-diaminobiphenyl, 3,3′-dimethoxy-4,4′-diaminobiphenyl, and 1,4-bis(4′-aminophenyl)benzene are more preferred.

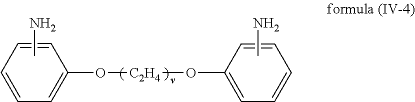

In formula (IV-4), v is an integer of 2 to 12.

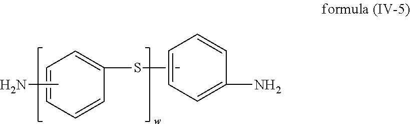

In formula (IV-5), w is an integer of 1 to 5. Preferably, formula (IV-5) is selected from 4,4′-diamino-diphenyl sulfide.

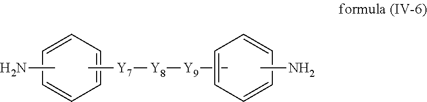

In formula (IV-6), Y₇ and Y₉ are the same or different and respectively represent a divalent organic group; and Y₈ represents a divalent group of a nitrogen atom-containing cyclic structure derived from, for instance, pyridine, pyrimidine, triazine, piperidine, or piperazine.

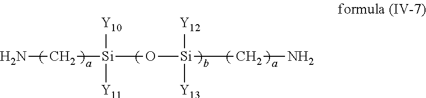

In formula (IV-7), Y₁₀, Y₁₁, Y₁₂, and Y₁₃ are the same or different and represent a C₁ to C₁₂ hydrocarbon group; a represents an integer of 1 to 3; and b represents an integer of 1 to 20.

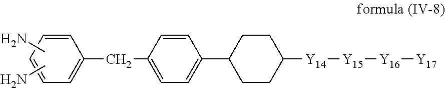

In formula (IV-8), Y₁₄ represents an oxygen atom or a cyclohexylene group; Y₁₅ represents —CH₂—; Y₁₆ represents a phenylene group or a cyclohexylene group; and Y₁₇ represents a hydrogen atom or a heptyl group.

The diamine compound represented by formula (IV-8) is preferably selected from diamine compounds represented by formula (IV-8-1) and formula (IV-8-2) below.

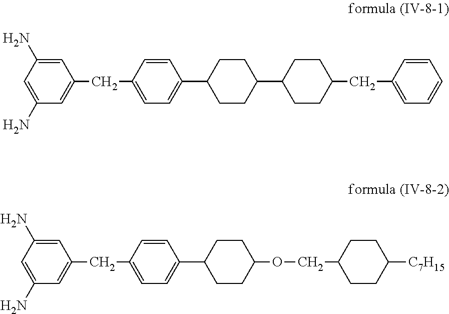

The diamine compounds represented by formula (IV-9) to formula (IV-30) are as shown below:

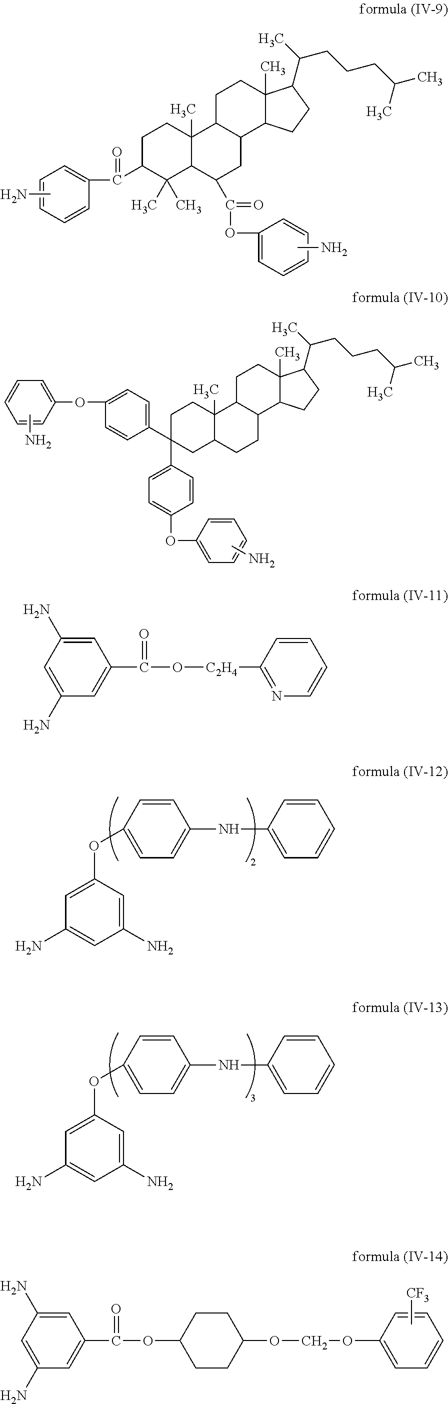

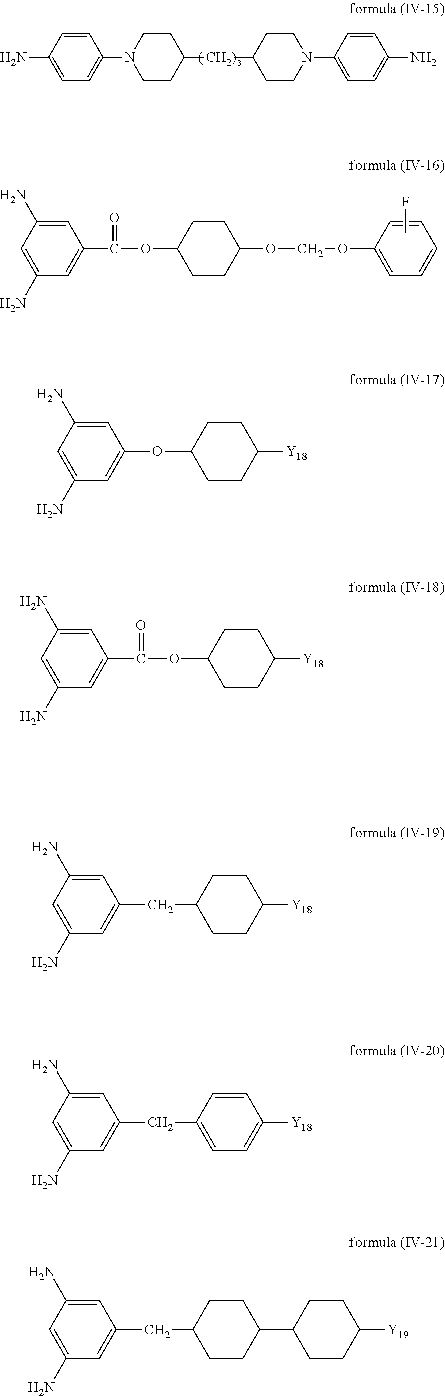

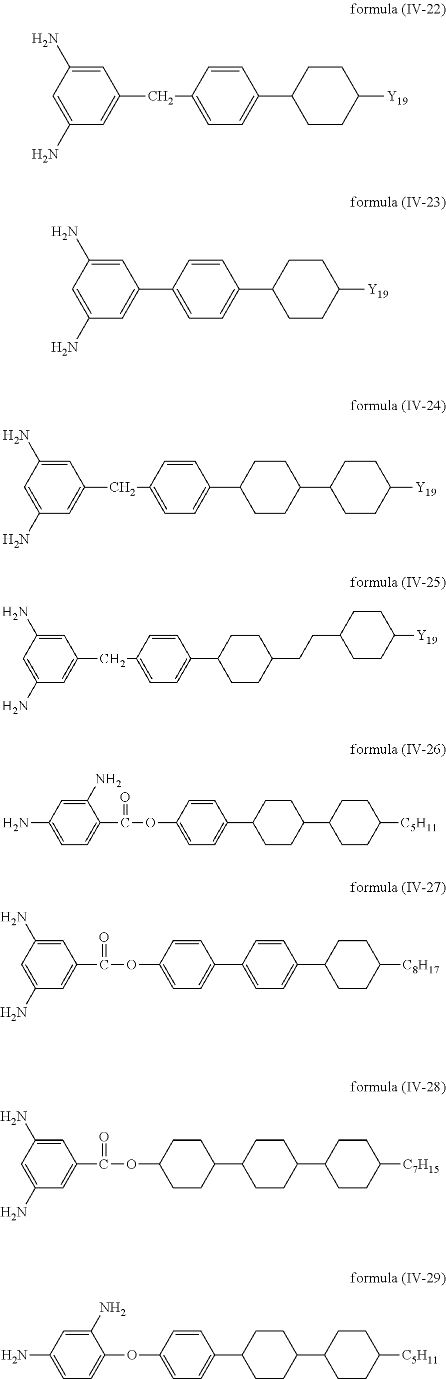

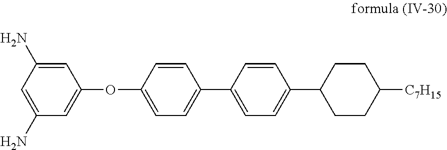

In formula (IV-17) to formula (IV-25), Y₁₈ is preferably a C₁ to C₁₀ alkyl group or a C₁ to C₁₀ alkoxy group, and Y₁₉ is preferably a hydrogen atom, a C₁ to C₁₀ alkyl group, or a C₁ to C₁₀ alkoxy group.

The other diamine compounds (b-2) are preferably 1,2-diaminoethane, 4,4′-diaminodicyclohexylmethane, 4,4′-diaminodiphenylmethane, 4,4′-diaminodiphenyl ether, 5-[4-(4-n-pentylcyclohexyl)cyclohexyl]phenylmethylene-1,3-diaminobenzene, 1,1-bis[4-(4-aminophenoxyl)phenyl]-4-(4-ethylphenyl)cyclohexane, ethyl 2,4-diaminophenyl formate, a compound represented by formula (IV-1-1), a compound represented by formula (IV-1-2), a compound represented by formula (IV-1-5), a compound represented by (IV-2-1), a compound represented by (IV-2-11), p-diaminobenzene, m-diaminobenzene, o-diaminobenzene, a compound represented by formula (IV-8-1), a compound represented by formula (IV-26), or a compound represented by formula (IV-29).

When the other diamine compounds (b-2) represented by formula (IV-1), formula (IV-2), formula (IV-8), or formula (IV-26) to formula (IV-30) are used in the liquid crystal alignment agent, the ion density of the liquid crystal display element fabricated by using the liquid crystal alignment agent after ultraviolet irradiation is lower.

The other diamine compounds (b-2) can be used alone or in multiple combinations.

Based on a total usage amount of 100 moles of the diamine component (b), the usage amount of the other diamine compounds (b-2) is generally 20 moles to 90 moles, preferably 30 moles to 85 moles, and more preferably 40 moles to 80 moles.

### [Synthesis Method of Polymer Composition (A)]

### <Polyamic Acid Polymer>

The preparation method of the polyamic acid polymer contains the following steps: a mixture including the tetracarboxylic dianhydride component (a) and the diamine component (b) is dissolved in a solvent, and then a polycondensation reaction is performed at a temperature condition of 0° C. to 100° C. for 1 hour to 24 hours. Next, distillation under reduced pressure is performed on the reaction solution with an evaporator to obtain the polyamic acid polymer. Alternatively, the reaction solution is poured into a large amount of a poor solvent to obtain a precipitate, and then a drying treatment is performed on the precipitate with a drying method under reduced pressure to obtain the polyamic acid polymer.

The solvent used in the polycondensation reaction can be the same or different as the solvent in the liquid crystal alignment agent, and the solvent used in the polycondensation reaction is not particularly limited, as long as the solvent can dissolve the reactants and the products. The solvent is preferably an aprotic polar solvent such as N-methyl-2-pyrrolidone, N,N-dimethyl acetamide, N,N-dimethyl formamide, dimethyl sulfoxide, γ-butyrolactone, tetramethylurea, or hexamethylphosphor amide; or a phenolic solvent such as m-cresol, xylenol, phenol, or halogenated phenol. Based on a total usage amount of 100 parts by weight of the mixture, the usage amount of the solvent used in the polycondensation reaction preferably ranges from 200 parts by weight to 2000 parts by weight; and the usage amount of the solvent used in the polycondensation reaction more preferably ranges from 300 parts by weight to 1800 parts by weight.

In particular, in the polycondensation reaction, the solvent can be used with a suitable amount of a poor solvent, wherein the poor solvent does not cause precipitation of the polyamic acid polymer. The poor solvent can be used alone or in multiple combinations, and contains, but is not limited to: (1) an alcohol such as methanol, ethanol, isopropanol, cyclohexanol, ethylene glycol, propylene glycol, 1,4-butanediol, or triethyleneglycol; (2) a ketone such as acetone, methyl ethyl ketone, methyl isobutyl ketone, or cyclohexanone; (3) an ester such as methyl acetate, ethyl acetate, butyl acetate, diethyl oxalate, diethyl malonate, or ethylene glycol monoethyl ether acetate; (4) an ether such as diethyl ether, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, or diethylene glycol dimethyl ether; (5) a halogenated hydrocarbon such as dichloromethane, 1,2-dichloroethane, 1,4-dichlorobutane, trichloroethane, chlorobenzene, or o-dichlorobenzene; or (6) a hydrocarbon such as tetrahydrofuran, hexane, heptane, octane, benzene, toluene, or xylene; or (7) a combination of the above. Preferably, based on a usage amount of 100 parts by weight of the diamine compound (a), the usage amount of the poor solvent ranges from 0 parts by weight to 60 parts by weight; more preferably, the usage amount of the poor solvent ranges from 0 parts by weight to 50 parts by weight.

### <Polyimide Polymer>

The preparation method of the polyimide polymer contains dissolving a mixture including the tetracarboxylic dianhydride component (a) and the diamine component (b) in a solvent, and then performing a polymerization reaction to form a polyamic acid polymer. Then, under the existence of a dehydrating agent and a catalyst, the mixture is further heated and a cyclodehydration reaction is performed such that the amic acid functional group in the polyamic acid polymer can be converted into an imide functional group (i.e., imidization) through the cyclodehydration reaction, thus obtaining the polyimide polymer.

The solvent used in the cyclodehydration reaction can be the same or different as the solvent in the liquid crystal alignment agent. Based on a usage amount of 100 parts by weight of the polyamic acid polymer, the usage amount of the solvent used in the cyclodehydration reaction preferably ranges from 200 parts by weight to 2,000 parts by weight; and the usage amount of the solvent used in the cyclodehydration reaction more preferably ranges from 300 parts by weight to 1,800 parts by weight.

If the operating temperature of the cyclodehydration reaction is less than 40° C., the reaction is incomplete, thus causing the degree of imidization of the polyamic acid polymer to be reduced. However, if the operating temperature of the cyclodehydration reaction is higher than 200° C., then the weight-average molecular weight of the obtained polyimide polymer is lower. Therefore, to obtain a preferable degree of imidization of the polyamic acid polymer, the operating temperature of the cyclodehydration reaction preferably ranges from 40° C. to 200° C.; and the operating temperature of the cyclodehydration reaction more preferably ranges from 40° C. to 150° C.

The dehydrating agent used in the cyclodehydration reaction can include: an acid anhydride compound such as acetic anhydride, propionic anhydride, or trifluoroacetic anhydride. Based on 1 mole of the polyamic acid polymer, the usage amount of the dehydrating agent ranges from 0.01 moles to 20 moles. The catalyst used in the cyclodehydration reaction can include: a pyridine compound such as pyridine, trimethyl pyridine, or dimethyl pyridine; or a tertiary amine compound such as triethylamine. Based on 1 mole of the dehydrating agent, the usage amount of the catalyst ranges from 0.5 moles to 10 moles.

### <Polyimide-Based Block Copolymer>

The steps contained in the preparation method of the polyimide-based block copolymer are: a starting material is dissolved in a solvent, and then a polycondensation reaction is performed to obtain the polyimide-based block copolymer, wherein the starting material includes at least one of the above polyamic acid polymer and/or at least one of the above polyimide polymer, and can further include a tetracarboxylic dianhydride component and a diamine component.

The tetracarboxylic dianhydride component and the diamine component in the starting material are the same as the tetracarboxylic dianhydride component (a) and the diamine component (b) used in the preparation of the polyamic acid polymer. Moreover, the solvent used in the polycondensation reaction can be the same as the solvent in the liquid crystal alignment agent.

Based on a usage amount of 100 parts by weight of the starting material, the usage amount of the solvent used in the polycondensation reaction preferably ranges from 200 parts by weight to 2000 parts by weight; and the usage amount of the solvent used in the polycondensation reaction more preferably ranges from 300 parts by weight to 1800 parts by weight. The operating temperature of the polycondensation reaction preferably ranges from 0° C. to 200° C.; and the operating temperature of the polycondensation reaction more preferably ranges from 0° C. to 100° C.

The starting material contains, but is not limited to (1) two polyamic acid polymers having different terminal groups and structure; (2) two polyimide polymers having different terminal groups and structure; (3) a polyamic acid polymer and a polyimide polymer having different terminal groups and structure; (4) a polyamic acid polymer, a tetracarboxylic dianhydride component, and a diamine component, wherein the structure of at least one of the tetracarboxylic dianhydride component and the diamine component is different from the structures of the tetracarboxylic dianhydride component and the diamine component used to form the polyamic acid polymer; (5) a polyimide polymer, a tetracarboxylic dianhydride component, and a diamine component, wherein the structure of at least one of the tetracarboxylic dianhydride component and the diamine component is different from the structures of the tetracarboxylic dianhydride component and the diamine component used to form the polyimide polymer; (6) a polyamic acid polymer, a polyimide polymer, a tetracarboxylic dianhydride component, and a diamine component, wherein the structure of at least one of the tetracarboxylic dianhydride component and the diamine component is different from the structures of the tetracarboxylic dianhydride component and the diamine component used to form the polyamic acid polymer and the polyimide polymer; (7) two polyamic acid polymers having different structures, a tetracarboxylic dianhydride component, and a diamine component; (8) two polyimide polymers having different structures, a tetracarboxylic dianhydride component, and a diamine component; (9) two polyamic acid polymers having anhydride groups as terminal groups and having different structures, and a diamine component; (10) two polyamic acid polymers having amine groups as terminal groups and having different structures, and a tetracarboxylic dianhydride component; (11) two polyimide polymers having anhydride groups as terminal groups and having different structures, and a diamine component; or (12) two polyimide polymers having amine groups as terminal groups and having different structures, and a tetracarboxylic dianhydride component.

Without affecting the efficacy of the invention, the polyamic acid polymer, the polyimide polymer, and the polyimide-based block copolymer are preferably terminal-modified polymers in which molecular weight regulation is first performed. By using the terminal-modified polymers, the coating performance of the liquid crystal alignment agent can be improved. The terminal-modified polymers are obtained by performing a polycondensation reaction on a polyamic acid polymer while adding a monofunctional compound. The monofunctional compound contains: (1) a monoacid anhydride such as maleic anhydride, phthalic anhydride, itaconic anhydride, n-decyl succinic anhydride, n-dodecyl succinic anhydride, n-tetradecyl succinic anhydride, or n-hexadecyl succinic anhydride; (2) a monoamine compound such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, or n-eicosylamine; or (3) a monoisocyanate compound such as phenyl isocyanate or naphthyl isocyanate.

### [Photopolymerizable Compound (B)]

The photopolymerizable compound (B) of the invention is, for instance, a compound represented by formula (1):

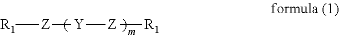

In formula (1), R₁ independently represents a polymerizable functional group represented by formula (1-1) to formula (1-5), a hydrogen atom, a halogen atom, —CN, —CF₃, —CF₂H, —CFH₂, —OCF₃, —OCF₂H, —N═C═O, —N═C═S, or a C₁ to C₂₀ alkyl group, wherein any —CH₂— in the alkyl group can be substituted by —O—, —S—, —SO₂—, —CO—, —COO—, —OCO—, —CH═CH—, —CF═CF—, or —C≡C—, and in the hydrogen atom-containing functional group, a hydrogen atom can optionally be substituted by a halogen atom or —CN; at least one R₁ is a polymerizable functional group represented by formula (1-1) to formula (1-5); Y independently represents a divalent group of a C₃ to C₂₁ saturated or unsaturated independent ring, condensed ring, or spiro ring, wherein in the ring, any —CH₂— can be substituted by —O—, any —CH═ can be substituted by —N═, any —H can be substituted by a halogen atom, —CN, —NO₂, —NC, —N═C═O, —N═C—S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group, and in the alkyl group, any —CH₂— can be substituted by —O—, —CO—, —COO—, —OCO—, —OCOO—, —CH═CH—, or —C≡C—; Z independently represents a single bond or a C₁ to C₂₀ alkylene group, wherein in the alkylene group, any —CH₂— can be substituted by —O—, —S—, —SO₂—, —CO—, —COO—, —OCO—, —OCOO—, —CH═CH—, —CF═CF—, —CH═N—, —N═CH—, —N═N—, —N(O)═N—, or —C≡C—, and any —H can be substituted by a halogen atom, a C₁ to C₁₀ alkyl group, or a C₁ to C₁₀ haloalkyl group; m represents an integer of 1 to 6, and when m is an integer of 2 to 6, a plurality of —Y—Z— can be the same or different.

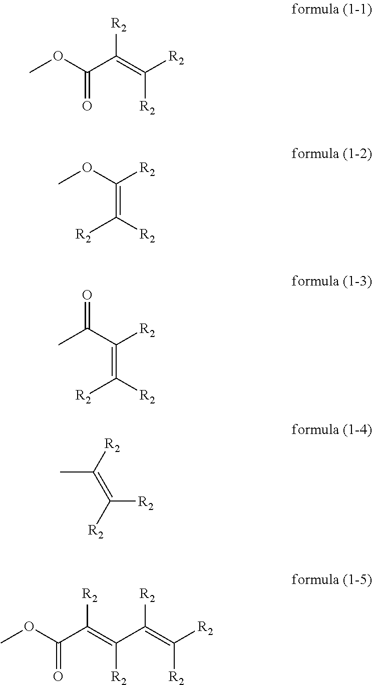

In formula (1-1) to formula (1-5), R₂ represents a hydrogen atom, a halogen atom, —CF₃, or a C₁ to C₅ alkyl group.

In formula (1), at least one R₁ is a polymerizable functional group represented by formula (1-1) to formula (1-3).

In formula (1), specific examples of the cyclic group represented by Y can include: a divalent group of 1,4-cyclohexylene, 1,4-cyclohexenylene, 1,4-phenylene, naphthalene-2,6-diyl, tetrahydronaphthalene-2,6-diyl, fluorene-2,7-diyl, bicyclo[2.2.2]octane-1,4-diyl, bicyclo[3.1.0]hexane-3,6-diyl, or triptycene-1,4-diyl. In the cyclic groups, any —CH₂— can be substituted by —O—, any —CH═ can be substituted by —N═, any —H can be substituted by a halogen atom, —CN, —NO₂, —NC, —N═C═O, —N═C—S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group. In the alkyl group, any —CH₂— can be substituted by —O—, —CO—, —COO—, —OCO—, —OCOO—, —CH═CH—, or —C≡C—.

From the viewpoint of further reducing the ion density of the liquid crystal alignment agent, the cyclic group represented by Y is preferably a group represented by formula (1-6) to formula (1-30):

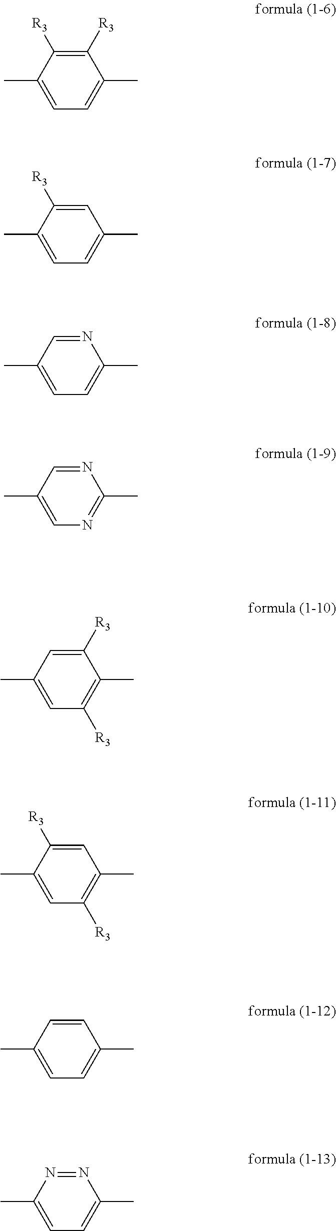

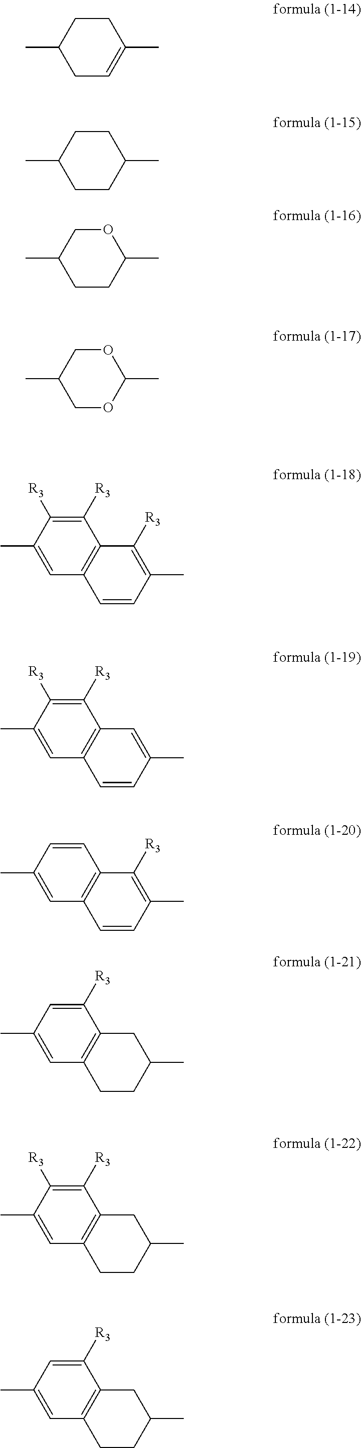

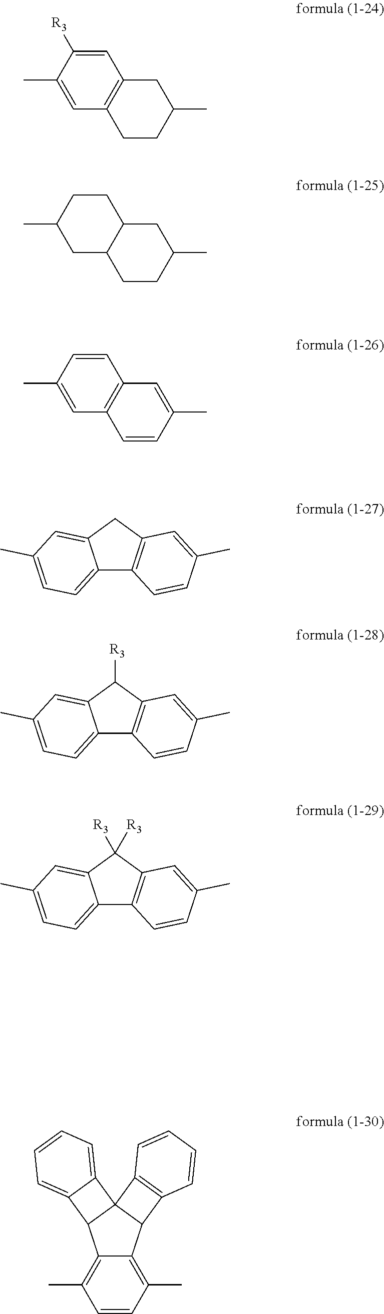

In formula (1-6) to formula (1-30), R₃ represents a halogen atom, a C₁ to C₃ alkyl group, a C₁ to C₃ alkoxy group, or a C₁ to C₃ haloalkyl group.

The photopolymerizable compound (B) is preferably a compound represented by formula (1-31) to formula (1-42):

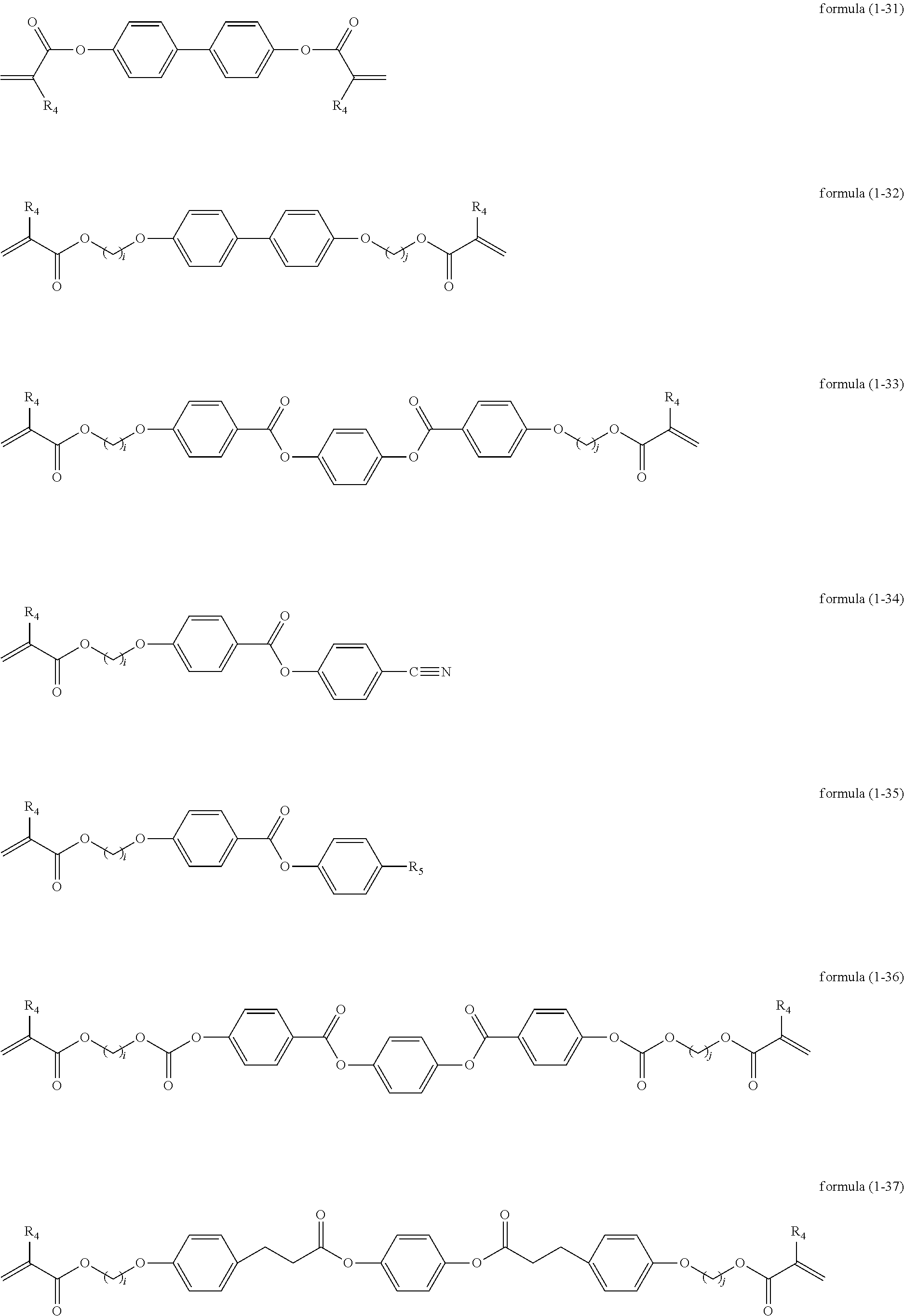

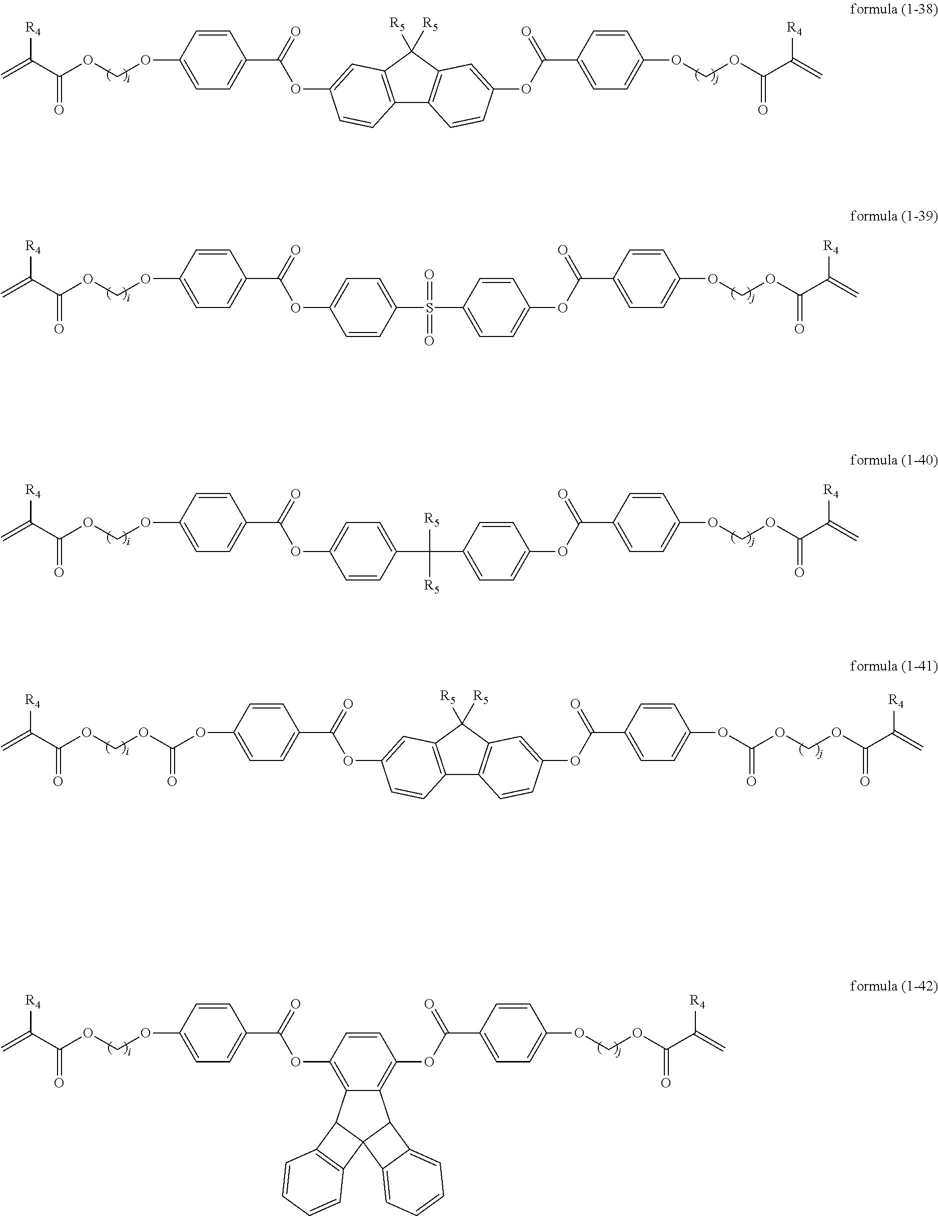

In formula (1-31) to formula (1-42), R₄ independently represents a hydrogen atom or a methyl group, and R₅ each independently represents a hydrogen atom, a halogen atom, a methyl group, —CF₃, —OCH₃, or a phenyl group, or 2 R₅ on the same carbon atom can form a C₆ to C₁₅ saturated or unsaturated hydrocarbon ring. i and j each independently represent an integer of 1 to 20.

The photopolymerizable compound (B) is preferably a compound represented by formula (1-43) to formula (1-97):

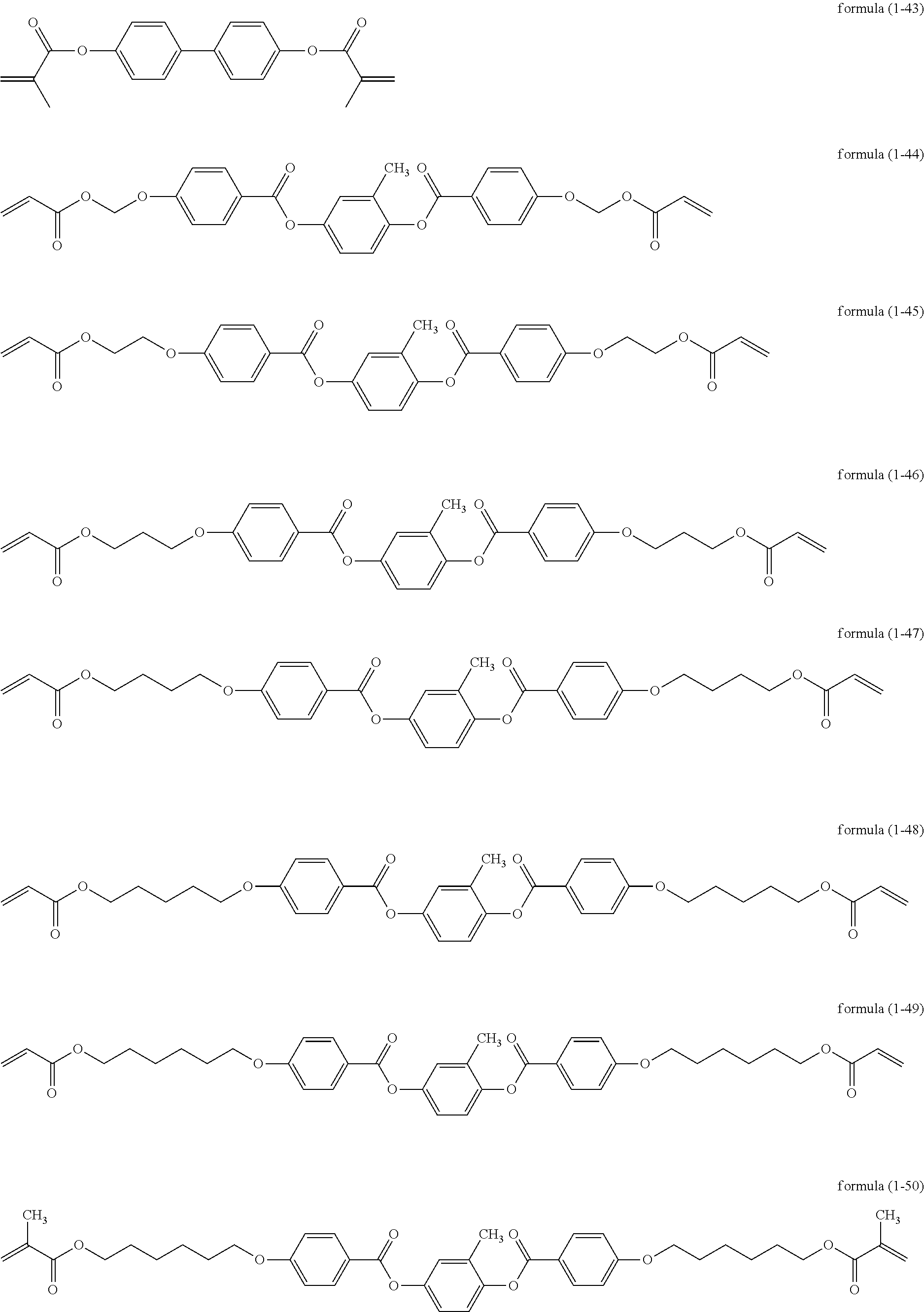

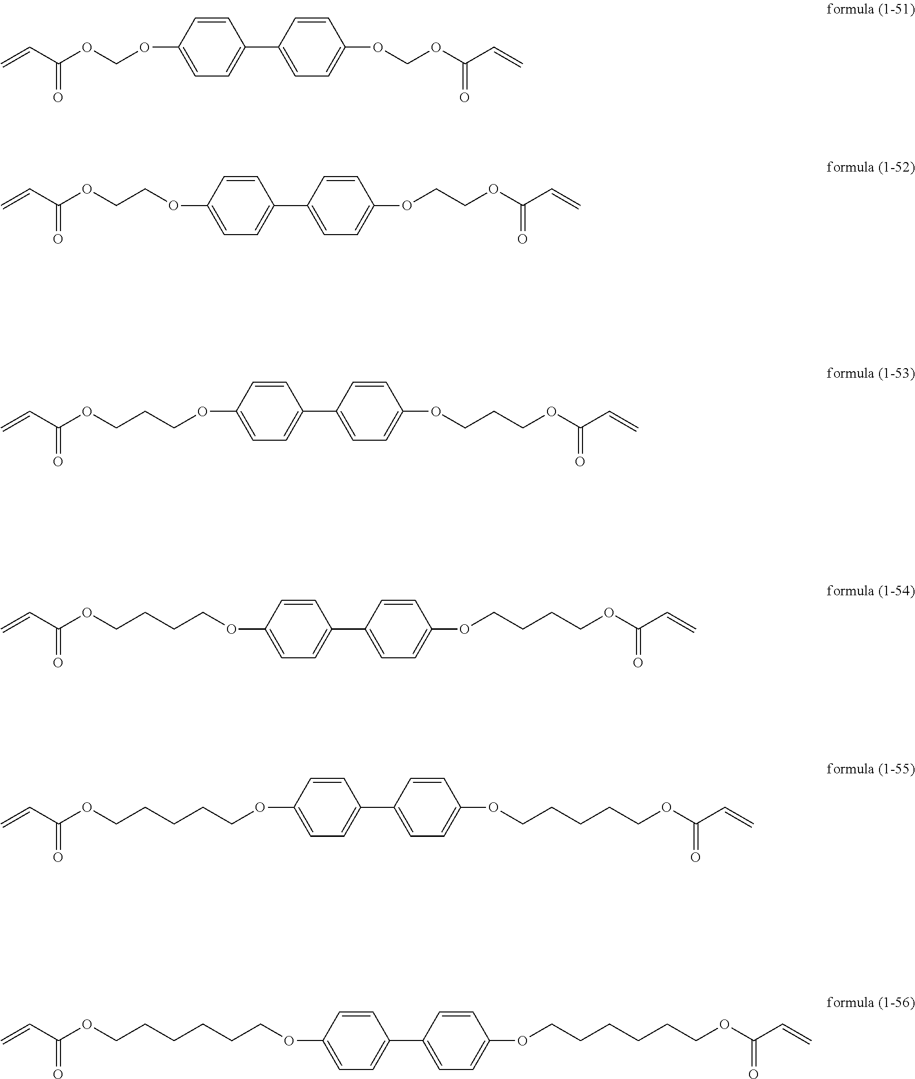

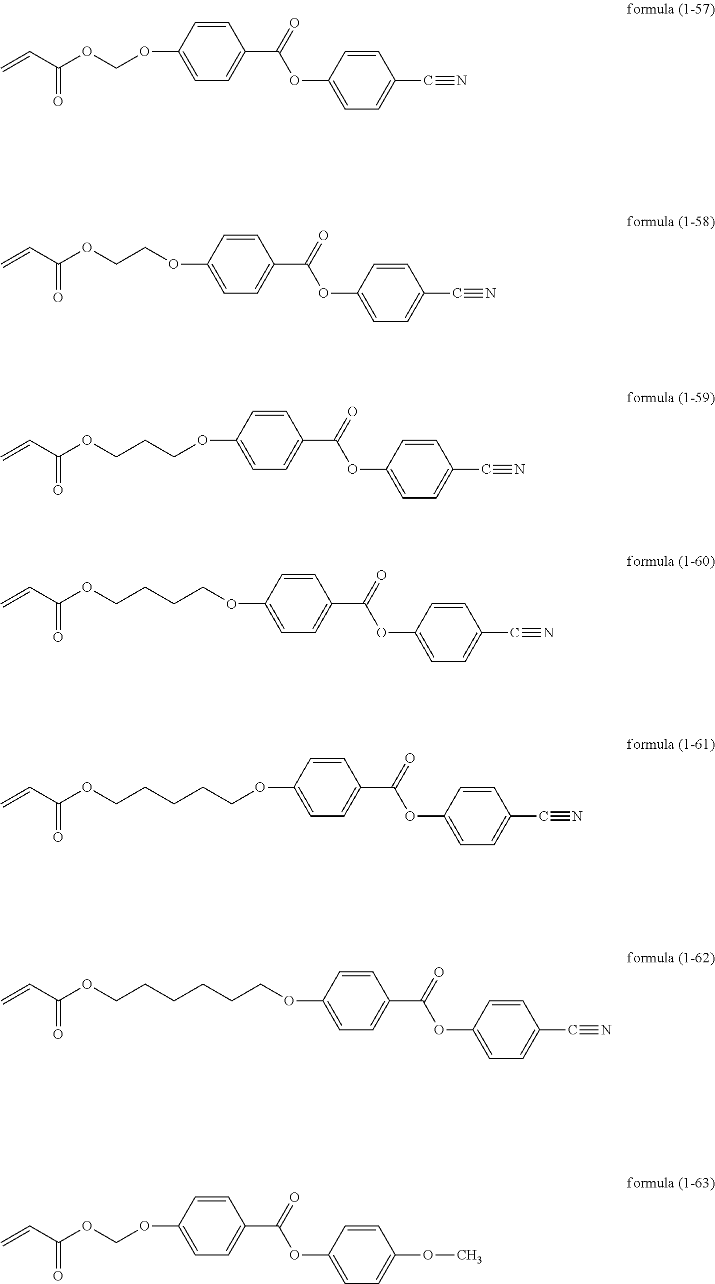

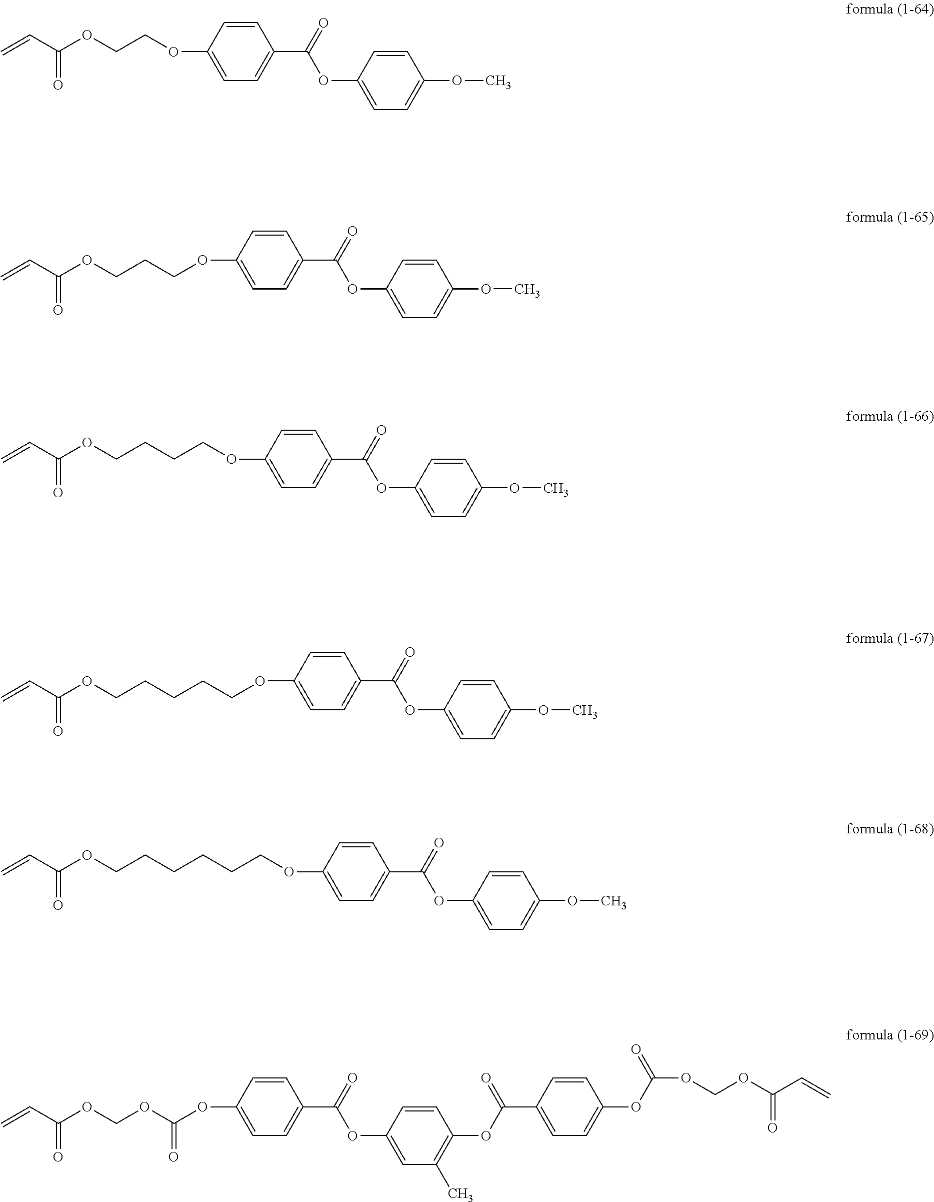

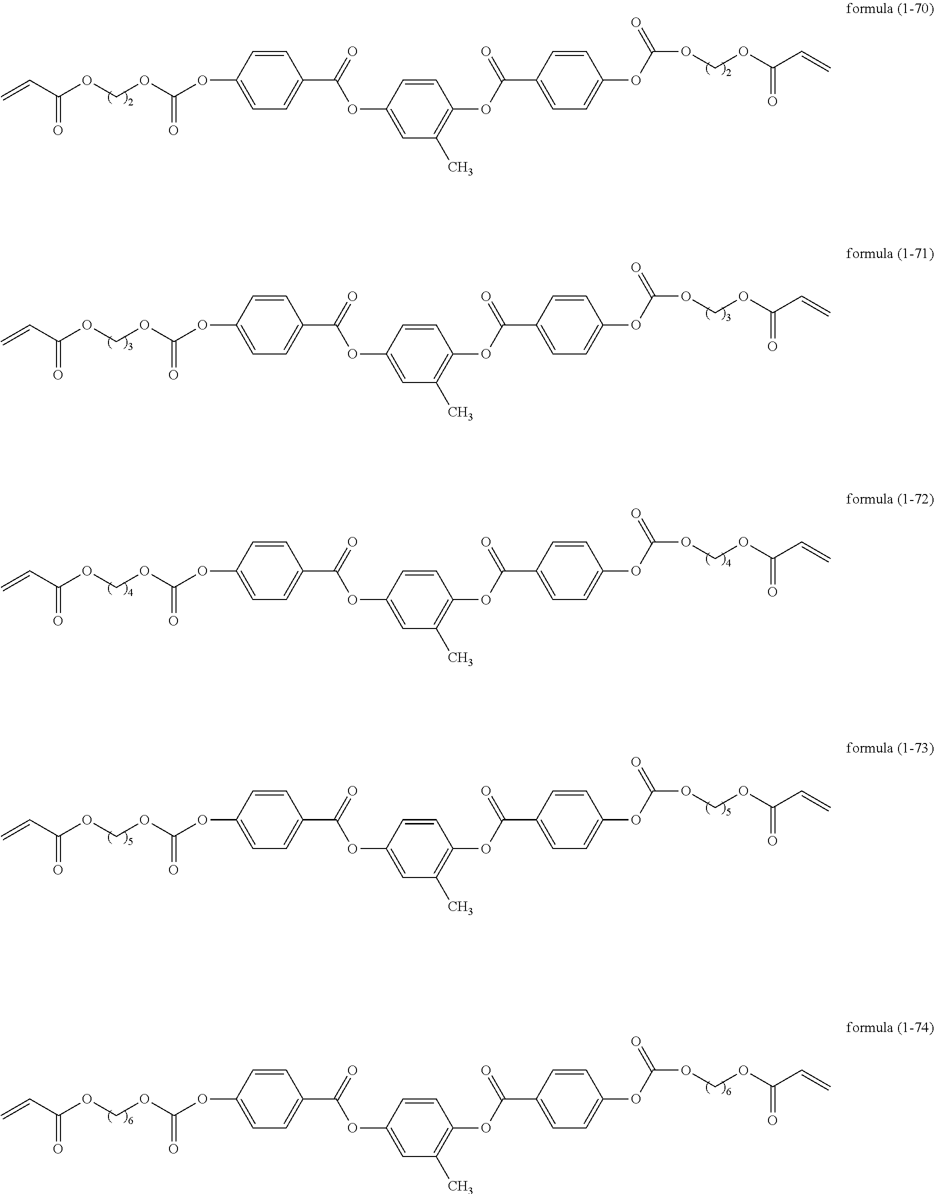

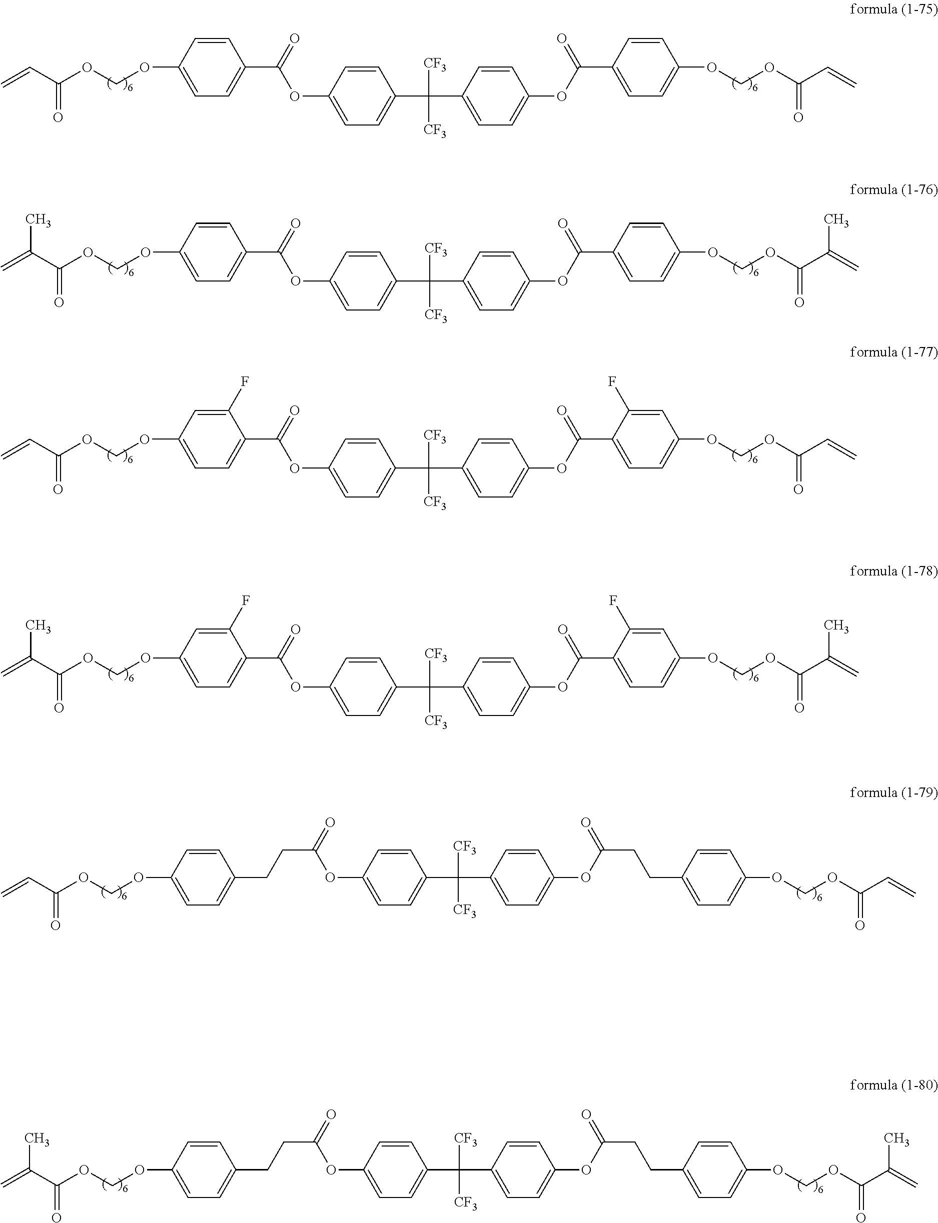

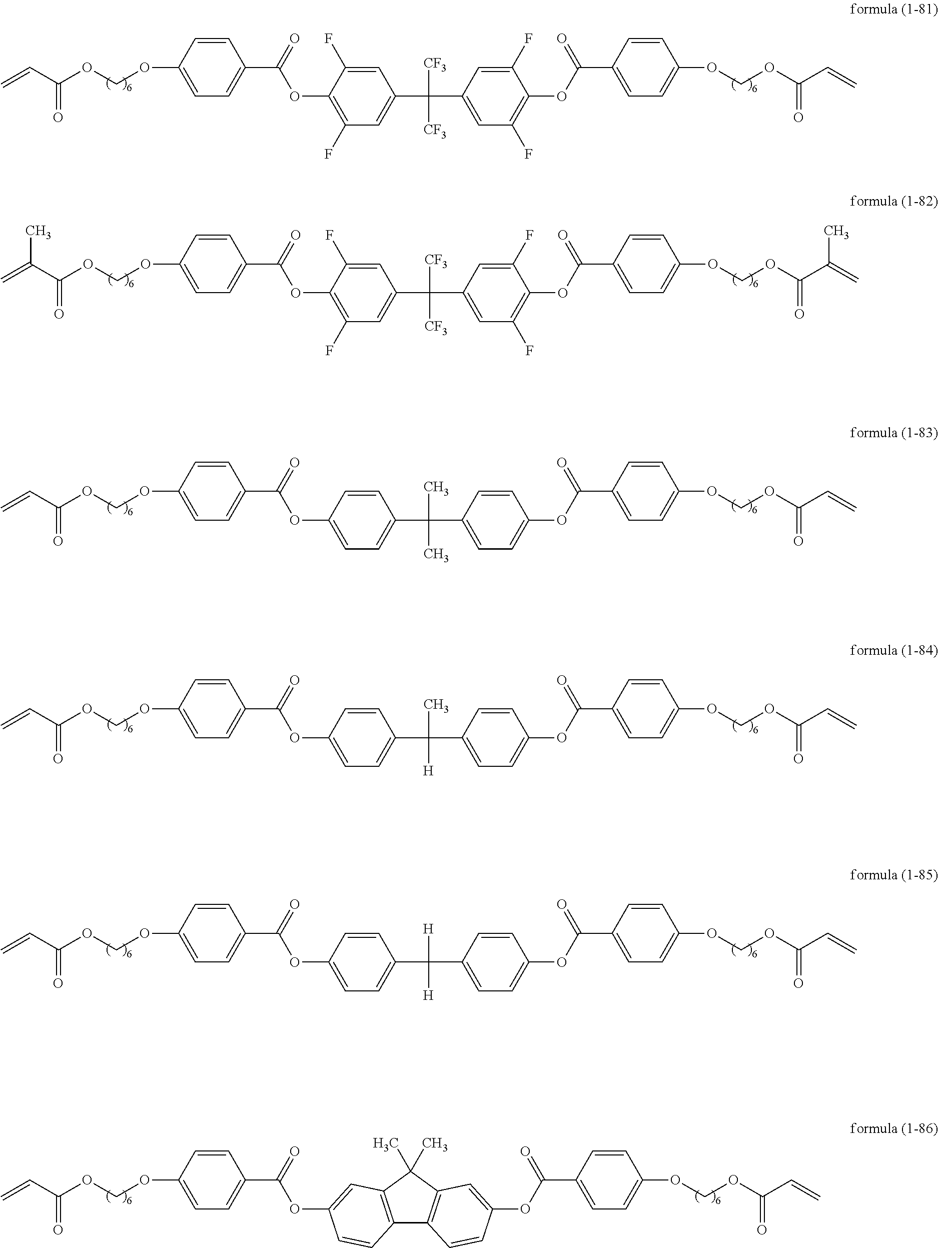

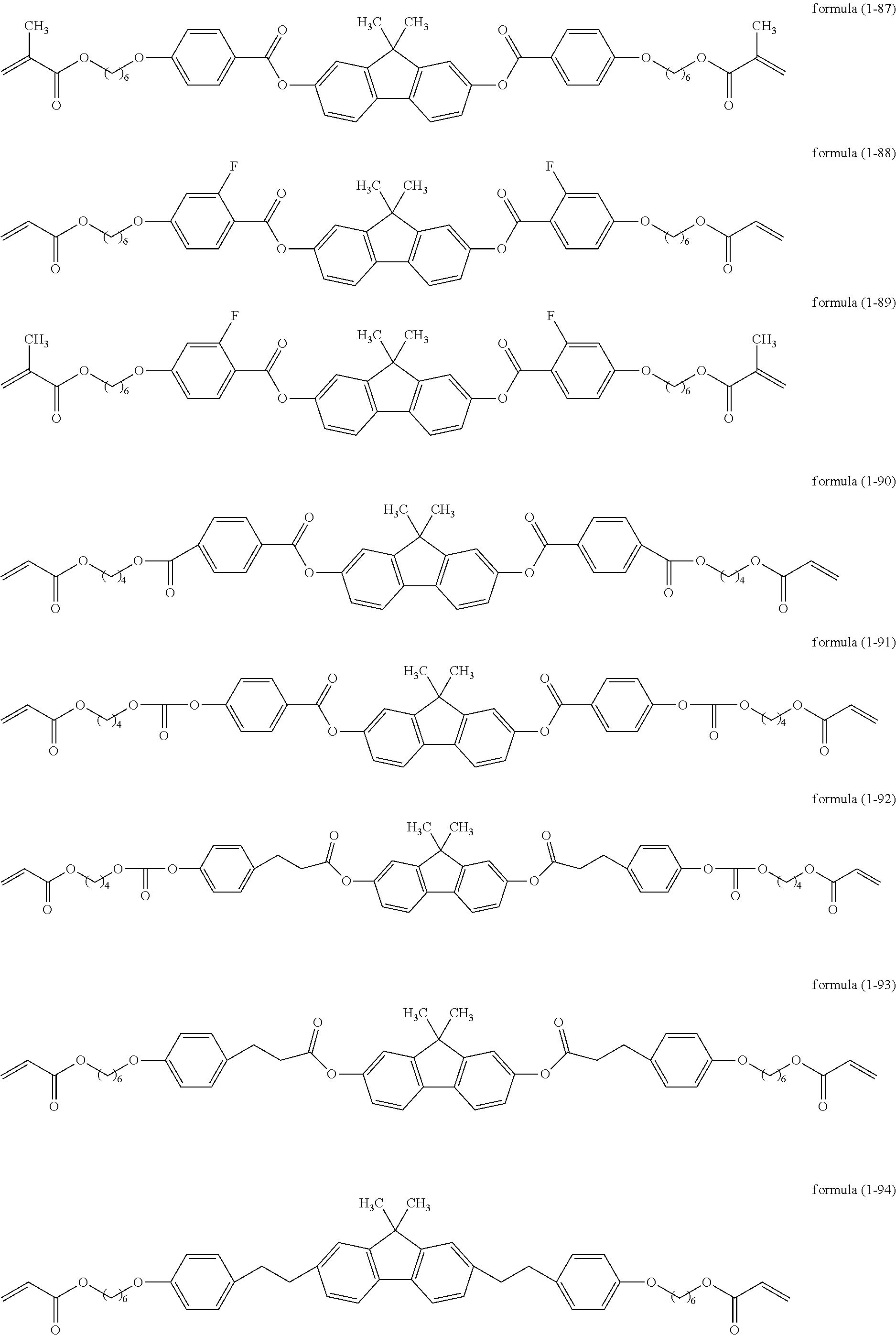

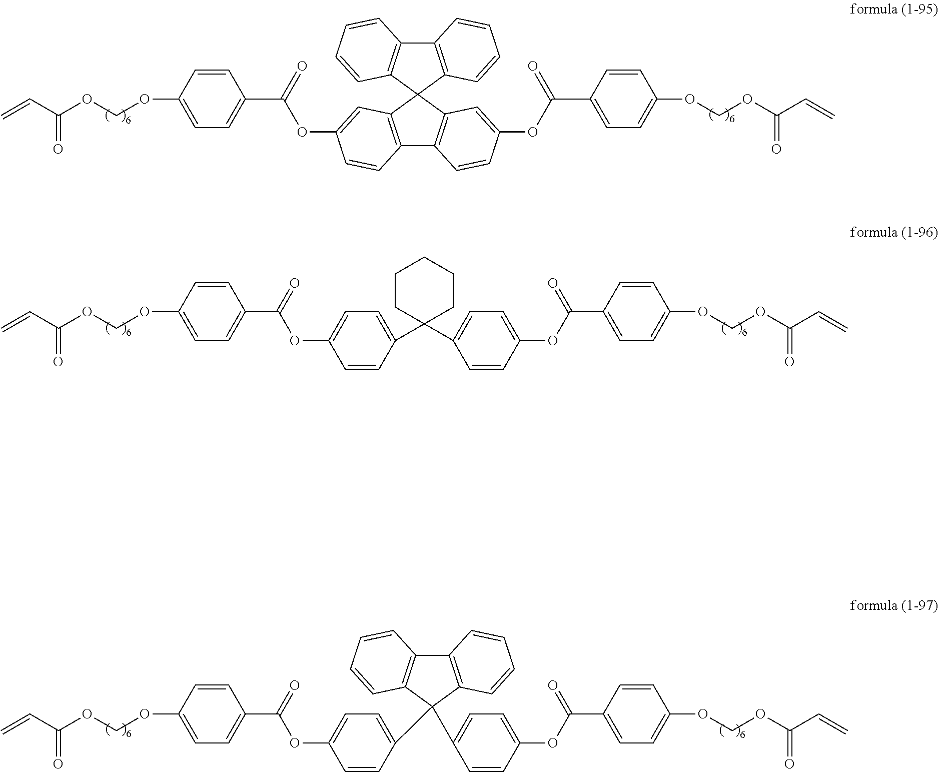

The photopolymerizable compound (B) is more preferably a compound represented by formula (1-44) to formula (1-50) or formula (1-69) to formula (1-97). When the photopolymerizable compound (B) is the compound represented by formula (1-44) to formula (1-50) or formula (1-69) to formula (1-97) and the prepared liquid crystal alignment agent is applied in a liquid crystal display element, the liquid crystal display element has lower ion density after ultraviolet irradiation.

The photopolymerizable compound (B) can be used alone or in multiple combinations.

Based on a usage amount of 100 parts by weight of the polymer composition (A), the usage amount of the photopolymerizable compound (B) is 5 parts by weight to 30 parts by weight, preferably 8 parts by weight to 25 parts by weight, and more preferably 10 parts by weight to 20 parts by weight.

If the photopolymerizable compound (B) is not used in the liquid crystal alignment agent, then the liquid crystal display element fabricated by using the liquid crystal alignment agent still has the issue of excessive ion density after ultraviolet irradiation.

### [Solvent (C)]

The solvent used in the liquid crystal alignment agent of the invention is preferably at least one compound selected from the group consisting of N-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, N,N-dimethyl formamide, and N,N-dimethyl acetamide. The solvent can be used alone or in multiple combinations.

Based on a usage amount of 100 parts by weight of the polymer composition (A), the usage amount of the solvent (C) is 500 parts by weight to 3000 parts by weight, preferably 800 parts by weight to 2500 parts by weight, and more preferably 1000 parts by weight to 2000 parts by weight.

### [Additive (D)]

Without affecting the efficacy of the invention, an additive (D) can also be added to the liquid crystal alignment agent of the invention, wherein the additive (D) is an epoxy compound, a silane compound having a functional group, or the like. The function of the additive (D) is to improve the adhesion of the liquid crystal alignment film and the surface of the substrate. The additive (D) can be used alone or in multiple combinations.

Specific examples of the silane compound having a functional group can include, for instance: 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, or N-bis(oxyethylene)-3-aminopropyltriethoxysilane.

Specific examples of the epoxy compound can include, for instance: ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, 2,2-dibromoneopentyl glycol diglycidyl ether, 1,3,5,6-tetraglycidyl-2,4-hexanediol, N,N,N′,N′-tetraglycidyl-m-xylenediamine, 1,3-bis(N,N-diglycidyl aminomethyl)cyclohexane, N,N,N′,N′-tetraglycidyl-4,4′-diaminodiphenyl methane, N,N-glycidyl-p-glycidyloxy aniline, 3-(N-allyl-N-glycidyl)aminopropyltrimethoxy silane, or 3-(N,N-diglycidyl)aminopropyltrimethoxysilane.

Based on a total usage amount of 100 parts by weight of the polymer composition (A), the usage amount of the additive (D) preferably ranges from 0.5 parts by weight to 50 parts by weight, more preferably 1 part by weight to 45 parts by weight.

### [Fabrication Method of Liquid Crystal Alignment Agent]

The preparation method of the liquid crystal alignment agent of the invention is not particularly limited, and a general mixing method can be used for the preparation. For instance: the polymer composition (A) and the photopolymerizable compound (B) formed by the above preparation method are first uniformly mixed into a mixture. Then, the solvent (C) is added to the mixture under a temperature condition of 0° C. to 200° C. Next, the additive (D) is optionally added, and lastly the mixture is continuously stirred with a stirring apparatus until dissolved. Preferably, the solvent (C) is added at a temperature of 20° C. to 60° C.

At 25° C., the viscosity of the liquid crystal alignment agent of the invention is generally 15 cps to 35 cps, preferably 17 cps to 33 cps, more preferably 20 cps to 30 cps.

### [Liquid Crystal Alignment Film]

The liquid crystal alignment agent of the invention is suitable for forming a liquid crystal alignment film through a photoalignment method.

The method of forming the liquid crystal alignment film can include, for instance, a method of coating the liquid crystal alignment agent on a substrate to form a coating film, and irradiating the coating film with polarized or non-polarized radiation from a direction inclined relative to the surface of the coating film; or irradiating the coating film with polarized radiation from a direction perpendicular to the surface of the coating film to provide liquid crystal alignment capability to the coating film.

First, the liquid crystal alignment agent of the invention is coated on one side of a transparent conductive film of a substrate on which a patterned transparent conductive film is disposed through a suitable coating method such as a roll coating method, a spin coating method, a printing method, or an ink-jet method. After coating, a pre-bake treatment is performed on the coating surface, and then a post-bake treatment is performed to form a coating film. The purpose of the pre-bake treatment is to volatilize the organic solvent in the pre-coat layer. The pre-bake treatment is, for instance, performed under the conditions of 0.1 minutes to 5 minutes at 40° C. to 120° C. The post-bake treatment is preferably performed under the condition of 120° C. to 300° C., more preferably 150° C. to 250° C., and is preferably performed for 5 minutes to 200 minutes, more preferably 10 minutes to 100 minutes. The film thickness of the coating film after post-bake is preferably 0.001 μm to 1 μm, more preferably 0.005 μm to 0.5 μm.

The substrate can include, for instance, a transparent substrate formed by a glass such as a float glass or a soda-lime glass; or a plastic such as poly(ethylene terephthalate), poly(butylene terephthalate), polyethersulfone, or polycarbonate.

The transparent conductive film can include, for instance, a NESA film formed by SnO₂ or an ITO (indium tin oxide) film formed by In₂O₃—SnO₂. To form the transparent conductive film patterns, a method such as photo-etching or a method in which a mask is used when the transparent conductive film is formed can be used.

When the liquid crystal alignment agent is coated, to improve the adhesion between the substrate or transparent conductive film and the coating film, a functional silane compound or a titanate compound . . . etc. can be pre-coated on the substrate and the transparent conductive film.

Then, liquid crystal alignment capability is provided by irradiating the coating film with polarized or non-polarized radiation, and a liquid crystal alignment film is formed by the coating film. Here, the radiation can include, for instance, ultraviolet and visible light having a wavelength of 150 nm to 800 nm, and preferably includes ultraviolet having a wavelength of 300 nm to 400 nm. When the radiation used is polarized light (linearly polarized light or partially polarized light), irradiation can be performed from a direction perpendicular to the surface of the coating film. Moreover, to provide pretilt angle, irradiation can also be performed from an inclined angle. Moreover, when non-polarized radiation is irradiated, irradiation needs to be performed from the direction inclined with respect to the surface of the coating film.

The light source of the radiation exposure can include, for instance, a low-pressure mercury lamp, a high-pressure mercury lamp, a deuterium lamp, a metal halide lamp, an argon resonance lamp, a xenon lamp, or a excimer laser. The ultraviolet in the preferred wavelength region can be obtained by, for instance, using the light sources with, for instance, a filter or a diffraction grating.

The radiation exposure is preferably equal to or greater than 1 J/m² and equal to or less than 10000 J/m², more preferably 10 J/m² to 3000 J/m². Moreover, when liquid crystal alignment capability is provided to a coating film formed by a conventionally known liquid crystal alignment agent through a photoalignment method, a radiation exposure equal to or greater than 10000 J/m² is needed. However, if the liquid crystal alignment agent of the invention is used, then even if the radiation exposure in the photoalignment method is equal to or less than 3000 J/m², further equal to or less than 1000 J/m², and further equal to or less than 300 J/m², good liquid crystal alignment capability can still be provided. As a result, the manufacturing costs of the liquid crystal display element can be reduced.

### [Liquid Crystal Display Element]

The liquid crystal display element of the invention includes the liquid crystal alignment film formed by the liquid crystal alignment agent of the invention. The liquid crystal display element of the invention can be made according to the following method.

Two substrates on which a liquid crystal alignment film is formed are prepared, and liquid crystal is disposed between the two substrates to make a liquid crystal cell. To make the liquid crystal cell, the following two methods can be provided.

The first method includes first disposing the two substrates opposite to each other with a gap (cell gap) in between such that the liquid crystal alignment films are opposite to each another. Then, the peripheries of the two substrates are laminated together with a sealant. Next, liquid crystal is injected into the cell gap divided by the surfaces of the substrates and the sealant, and then the injection hole is sealed to obtain the liquid crystal cell.

The second method is called ODF (one drop fill, instillation). First, an ultraviolet curable sealing material for instance is coated on a predetermined portion on one of the two substrates on which a liquid crystal alignment film is formed. Then, liquid crystal is dropped onto the liquid crystal alignment film, and then the other substrate is laminated such that the liquid crystal alignment films are opposite to each other. Next, ultraviolet is irradiated on the entire surface of the substrates such that the sealant is cured. The liquid crystal cell can thus be made.

When any one of the above methods is used, preferably, after the liquid crystal cell is next heated to the temperature at which the liquid crystal used is in an isotropic phase, the liquid crystal cell is slowly cooled to room temperature to remove flow alignment when the liquid crystal is filled.

Next, by adhering a polarizer on the outer surface of the liquid crystal cell, the liquid crystal display element of the invention can be obtained. Here, when the liquid crystal alignment films have parallel alignment capability, a liquid crystal display element having a TN-type or STN-type liquid crystal cell can be obtained by adjusting the angle formed by the polarization direction of the linear polarized radiation irradiated in the two substrates on which a liquid crystal alignment film is formed and the angle of each substrate and the polarizer. Moreover, when the liquid crystal alignment films have vertical alignment capability, a liquid crystal display element having a vertical alignment-type liquid crystal cell can be obtained by constructing the liquid crystal cell so that the directions of easy-to-align axis of the two substrates on which a liquid crystal alignment film is formed are parallel; and by adhering a polarizer with the liquid crystal cell, the polarization direction thereof and the easy-to-align axis form a 45° angle.

Specific examples of the sealant include, for instance, an epoxy resin containing an alumina ball used as a spacer or a curing agent.

Specific examples of the liquid crystal include, for instance, a nematic liquid crystal or a smectic liquid crystal.

When a TN-type or STN-type liquid crystal cell is used, the TN-type or STN-type liquid crystal cell preferably has a nematic liquid crystal having positive dielectric anisotropy, and examples thereof can include, for instance, a biphenyl-based liquid crystal, a phenyl cyclohexane-based liquid crystal, an ester-based liquid crystal, a terphenyl-based liquid crystal, a biphenyl cyclohexane-based liquid crystal, a pyrimidine-based liquid crystal, a dioxane-based liquid crystal, a bicyclooctane-based liquid crystal, or a cubane-based liquid crystal. Moreover, a cholesteric liquid crystal such as cholesteryl chloride, cholesteryl nonabenzoate, or cholesteryl carbonate . . . etc., a chiral agent sold under the product name of “C-15” or “CB-15” (made by Merck & Co.), or a ferroelectric liquid crystal such as p-decyloxybenzylidene-p-amino-2-methyl butyl cinnamate can further be added to the liquid crystal above.

Moreover, when a vertical alignment-type liquid crystal cell is used, the vertical alignment-type liquid crystal cell preferably has a nematic liquid crystal having negative dielectric anisotropy, and examples thereof can include, for instance, a dicyanobenzene-based liquid crystal, a pyridazine-based liquid crystal, a Schiff base-based liquid crystal, an azoxy-based liquid crystal, a biphenyl-based liquid crystal, or a phenyl cyclohexane-based liquid crystal.

The polarizer used on the outside of the liquid crystal cell can include, for instance, a polarizer formed by a polarizing film known as “H film” obtained by clamping polyvinyl alcohol which is stretched aligned and absorbs iodine with a cellulose acetate protective film, or a polarizer formed by the “H film” itself.

The liquid crystal display element of the invention thus made has excellent display performance, and even after prolonged use, the display performance is not worsened.

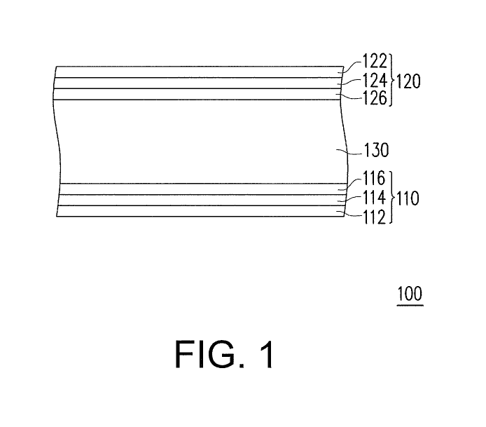

FIG. 1 is a side view of a liquid crystal display element according to an embodiment of the invention. A liquid crystal display element 100 includes a first unit 110, a second unit 120, and a liquid crystal unit 130, wherein the second unit 120 and the first unit 110 are separately disposed and the liquid crystal unit 130 is disposed between the first unit 110 and the second unit 120.

The first unit 110 includes a first substrate 112, a first conductive film 114, and a first liquid crystal alignment film 116, wherein the first conductive film 114 is located between the first substrate 112 and the first liquid crystal alignment film 116, and the first liquid crystal alignment film 116 is located on one side of the liquid crystal unit 130.

The second unit 120 includes a second substrate 122, a second conductive film 124, and a second liquid crystal alignment film 126, wherein the second conductive film 124 is located between the second substrate 122 and the second liquid crystal alignment film 126, and the second liquid crystal alignment film 126 is located on another side of the liquid crystal unit 130. In other words, the liquid crystal unit 130 is located between the first liquid crystal alignment film 116 and the second liquid crystal alignment film 126.

The first substrate 112 and the second substrate 122 are selected from, for instance, a transparent material, wherein the transparent material includes, but is not limited to, for instance, alkali-free glass, soda-lime glass, hard glass (Pyrex glass), quartz glass, polyethylene terephthalate, polybutylene terephthalate, polyethersulfone, or polycarbonate for a liquid crystal display apparatus. The material of each of the first conductive film 114 and the second conductive film 124 is selected from, for instance, tin oxide (SnO₂) or indium oxide-tin oxide (In₂O₃—SnO₂).

The first liquid crystal alignment film 116 and the second liquid crystal alignment film 126 are respectively the above liquid crystal alignment films, and the function thereof is to make the liquid crystal unit 130 form a pretilt angle. Moreover, when a voltage is applied to the first conductive film 114 and the second conductive film 124, an electric field can be generated between the first conductive film 114 and the second conductive film 124. The electric field can drive the liquid crystal unit 130, thereby causing change to the arrangement of the liquid crystal molecules in the liquid crystal unit 130.

The following examples are used to further describe the invention. However, it should be understood that, the examples are only exemplary, and are not intended to limit the implementation of the invention.

### EXAMPLES

### Preparation of Polymer Composition

### Synthesis Example A-1-1

A nitrogen inlet, a stirrer, a condenser, and a thermometer were provided in a four-neck flask having a volume of 500 ml, and then nitrogen gas was introduced. Then, 7.47 g (0.015 moles) of a diamine compound (b-1-1) of formula (II-1-3), 3.78 g (0.035 moles) of p-diaminobenzene (b-2-1), and 80 g of N-methyl-2-pyrrolidone (hereinafter NMP) were added, and the mixture was stirred at room temperature until dissolved. Next, 10.91 g (0.05 moles) of pyromellitic dianhydride (a-1) and 20 g of NMP were added, and the mixture was reacted at room temperature for 2 hours. After the reaction was complete, the reaction solution was poured into 1500 ml of water to precipitate a polymer. Then, the obtained polymer was filtered and the steps of washing with methanol and filtration were performed repeatedly three times. Next, the product was placed in a vacuum oven, and drying was performed at a temperature of 60° C. to obtain a polymer composition (A-1-1).

### Synthesis Examples A-1-2 to A-1-12

Polymer compositions A-1-2 to A-1-12 were respectively prepared with the same method as synthesis example A-1-1 except the type and the usage amount of the tetracarboxylic dianhydride component (a) and the diamine component (b) were different. The type and the usage amount of the tetracarboxylic dianhydride component (a) and the diamine component (b) used in the polymer compositions A-1-2 to A-1-12 are as shown in Table 1, wherein the compounds corresponding to the labels in Table 1 are as shown below:

### Synthesis Example A-2-1

A nitrogen inlet, a stirrer, a condenser, and a thermometer were provided in a four-neck flask having a volume of 500 ml, and then nitrogen gas was introduced. Then, 7.47 g (0.015 moles) of the diamine compound (b-1-1) of formula (II-1-3), 3.78 g (0.035 moles) of p-diaminobenzene (b-2-1), and 80 g of N-methyl-2-pyrrolidone (hereinafter NMP) were added, and the mixture was stirred at room temperature until dissolved. Next, 10.91 g (0.05 moles) of pyromellitic dianhydride (a-1) and 20 g of NMP were added. After the mixture was reacted at room temperature for 6 hours, 97 g of NMP, 2.55 g of acetic anhydride, and 19.75 g of pyridine were added. Then, the temperature was raised to 60° C., and the mixture was continuously stirred for 2 hours to perform an imidization reaction. After the reaction was complete, the reaction solution was poured into 1500 ml of water to precipitate a polymer. Then, the obtained polymer was filtered and the steps of washing with methanol and filtration were performed repeatedly three times. Then, the product was placed in a vacuum oven, and drying was performed at a temperature of 60° C. to obtain a polymer composition (A-2-1).

### Synthesis Examples A-2-2 to A-2-5

Polymer compositions A-2-2 to A-2-5 were respectively prepared with the same method as synthesis example A-2-1 except the type and the usage amount of the tetracarboxylic dianhydride component (a) and the diamine component (b) were different. The type and the usage amount of the tetracarboxylic dianhydride component (a) and the diamine component (b) used in the polymer compositions A-2-2 to A-2-5 are as shown in Table 1, wherein the compounds corresponding to the labels in Table 1 are as shown below.

| Abbreviation | Component |
|---|---|
| a-1 | pyromellitic dianhydride |
| a-2 | 1,2,3,4-cyclobutane tetracarboxylic dianhydride |
| a-3 | 2,3,5-tricarboxycyclopentylacetic dianhydride |
| b-1-1 | 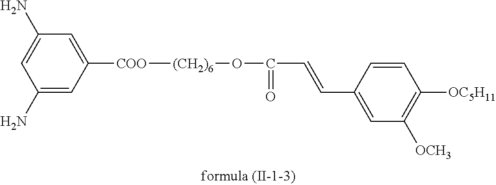 |
| b-1-2 | 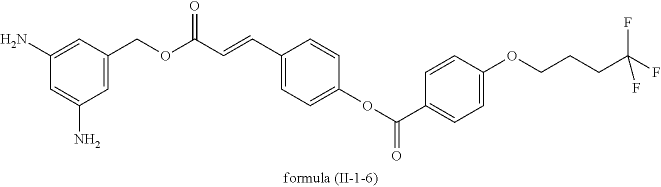 [SMILES: Nc1cc(N)cc(COC(=O)/C=C/c2ccc(OC(=O)c3ccc(OCCCC(F)(F)F)cc3)cc2)c1] |
| b-1-3 | 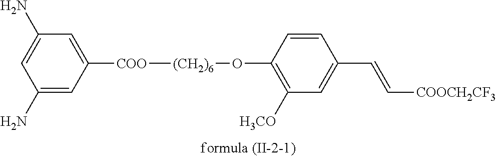 |
| b-1-4 | 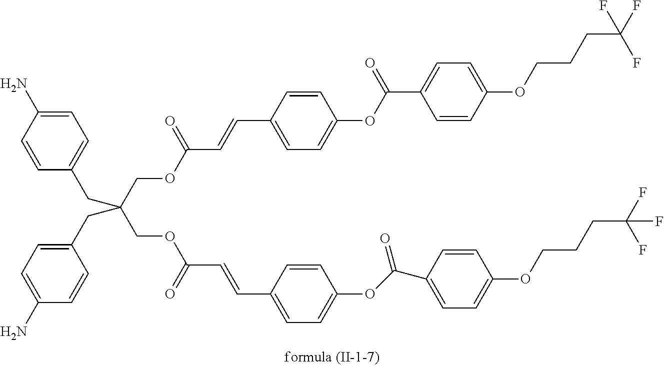 [SMILES: Nc1ccc(CC(COC(=O)/C=C/c2ccc(OC(=O)c3ccc(OCCCC(F)(F)F)cc3)cc2)(COC(=O)/C=C/c2ccc(OC(=O)c3ccc(OCCCC(F)(F)F)cc3)cc2)Cc2ccc(N)cc2)cc1] |
| b-2-1 | p-diaminobezene |
| b-2-2 | 4,4′-diaminodiphenylmethane |
| b-2-3 | 4,4′-diaminodiphenyl ether |
| b-2-4 | 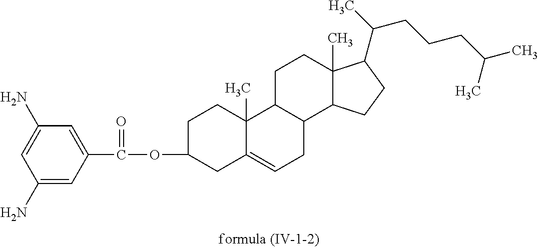 [SMILES: CC(C)CCCC(C)C1CCC2C3CC=C4CC(OC(=O)c5cc(N)cc(N)c5)CCC4(C)C3CCC12C] |
| b-2-5 | 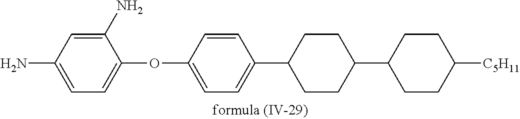 |
| b-2-6 | 3,3′-diaminochalcone |
| b-2-7 | 4,4′-diaminostilbene |

TABLE 1

| | | | Synthesis example | | | | | | | | | | | | | | | | |
|---|---|---|---|---|---|---|---|---|---|---|---|---|---|---|---|---|---|---|---|
| Component | | | | | | | | | | | | A- | A- | A- | | | | | |
| (unit: mole %) | | | A-1-1 | A-1-2 | A-1-3 | A-1-4 | A-1-5 | A-1-6 | A-1-7 | A-1-8 | A-1-9 | 1-10 | 1-11 | 1-12 | A-2-1 | A-2-2 | A-2-3 | A-2-4 | A-2-5 |
| Tetracarboxylic | | a-1 | 100 | | | 100 | | | 100 | | | 70 | 100 | | 100 | | | 100 | |
| dianhydride | | a-2 | | 100 | 50 | | 100 | 50 | | | 100 | 30 | | 100 | | 100 | 50 | | 100 |
| component | | a-3 | | | 50 | | | 50 | | 100 | | | | | | | 50 | | |
| (a) | | | | | | | | | | | | | | | | | | | |
| Di- | Diamine | b-1-1 | 30 | | | | | | 40 | | | | | | 30 | | | | |
| amine | compound | b-1-2 | | 20 | | | 15 | | 30 | 80 | | | | | | 20 | | | |
| com- | (b-1) | b-1-3 | | | 10 | | | 50 | | | 30 | | | | | | 10 | | |
| ponent | | b-1-4 | | | | 40 | | | | | 30 | 25 | | | | | | | |
| (b) | Diamine | b-2-1 | 70 | | | | 80 | | | 10 | 40 | | 70 | | 70 | | | 70 | |
| | compound | b-2-2 | | 80 | | 50 | | 40 | 30 | | | | | 80 | | 80 | | | 80 |
| | (b-2) | b-2-3 | | | 90 | | | 10 | | | | 65 | | | | | 70 | | |
| | | b-2-4 | | | | 10 | | | | | | | | | | | | | |
| | | b-2-5 | | | | | | | | 10 | | | | | | | 20 | | |
| | | b-2-6 | | | | | 5 | | | | | | 30 | | | | | 30 | |
| | | b-2-7 | | | | | | | | | | 10 | | 20 | | | | | 20 |

### Preparation of Liquid Crystal Alignment Agent, Liquid Crystal Alignment Film, and Liquid Crystal Display Element

### Example 1

100 parts by weight of the polymer composition (A-1-1) and 10 parts by weight of a photopolymerizable compound (B-1) of formula (1-43) were added to 1200 parts by weight of NMP (hereinafter C-1) and 600 parts by weight of ethylene glycol n-butyl ether (hereinafter C-2). Then, the mixture was continuously stirred at room temperature with a stirring apparatus until dissolved to obtain a liquid crystal alignment agent.

The liquid crystal alignment agent was coated on a glass substrate having a layer of conductive film formed by ITO with a spin coating method. Then, pre-bake was performed on a heating plate at a temperature of 100° C. for 5 minutes, and post-bake was performed in a circulation oven at a temperature 220° C. for 30 minutes, thereby obtaining a coating film.

A Hg—Xe lamp and a Glan-Taylor prism were used to irradiate the surface of the coating film with polarized ultraviolet containing a 313 nm bright line for 50 seconds from a direction inclined 45° from the normal of the substrate, thereby providing liquid crystal alignment capability. A liquid crystal alignment film was thus fabricated. Here, the illumination of the irradiated surface under a wavelength of 313 nm was 2 mW/cm². The same operation was performed to fabricate 2 (1 pair) substrates having a coating film (liquid crystal alignment film) on which a polarized ultraviolet irradiation treatment was performed.

Next, an epoxy resin sealant containing an alumina ball having a diameter of 5.5 μm was coated on the periphery of the surface of the pair of substrates on which a liquid crystal alignment film was formed with screen printing, and then the substrates were laminated in a manner that the liquid crystal alignment film of each substrate was opposite to each other, and the irradiation direction of the polarized ultraviolet was antiparallel, and then a pressure of 10 kg was applied with a hot press to perform hot press lamination at 150° C.

Next, liquid crystal was injected from a liquid crystal injection hole, and an epoxy resin-based sealant was used to seal the liquid crystal injection hole. To remove flow alignment when liquid crystal was injected, the liquid crystal was heated to 150° C. and then slowly cooled to room temperature. Lastly, polarizers were laminated on two sides on the outside of the substrates in a manner that the polarization directions of the polarizers were perpendicular to each other and form 45° with the polarization direction of the ultraviolet of the liquid crystal alignment film.

### Example 2 to Example 15

The liquid crystal alignment agent, the liquid crystal alignment film, and the liquid crystal display element of each of example 2 to example 15 were prepared with the same method as example 1 except the type and the usage amount of the components of the liquid crystal alignment agents were different. The type and the usage amount of the components of the liquid crystal alignment agents used in example 2 to example 15 are as shown in Table 2, wherein the compounds corresponding to the labels of Table 2 are as shown below. The liquid crystal display elements formed by the obtained liquid crystal alignment agents were evaluated by the following evaluation methods, and the results thereof are as shown in Table 2.

| Abbrevi- | |
|---|---|
| ation | Component |
| B-1 | Photopolymerizable compound represented by formula (1-43) |
| B-2 | Photopolymerizable compound represented by formula (1-52) |
| B-3 | Photopolymerizable compound represented by formula (1-47) |
| B-4 | Photopolymerizable compound represented by formula (1-70) |
| B-5 | Photopolymerizable compound represented by formula (1-76) |
| B-6 | Photopolymerizable compound represented by formula (1-86) |
| C-1 | N-methyl-2-pyrrolidone |
| C-2 | ethylene glycol n-butyl ether |
| C-3 | N,N-dimethylacetamide |
| D-1 | N,N,N′,N′-tetraglycidyl-4′-diamino diphenyl methane |
| D-2 | N,N-glycidyl-p-glycidyloxy aniline |

### Comparative Example 1 to Comparative Example 5

The liquid crystal alignment agent, the liquid crystal alignment film, and the liquid crystal display element of each of comparative example 1 to comparative example 5 were prepared with the same method as example 1 except the type and the usage amount of the components of the liquid crystal alignment agents were different. The type and the usage amount of the components of the liquid crystal alignment agents used in comparative example 1 to comparative example 5 are as shown in Table 2. The liquid crystal display elements formed by the obtained liquid crystal alignment agents were evaluated by the following evaluation methods, and the results thereof are as shown in Table 2.

The obtained liquid crystal display elements were evaluated with the following evaluation methods, and the obtained results are as shown in Table 2.

[Evaluation Methods]

<Ion Density>

After the liquid crystal display element of each of examples 1 to 15 and comparative examples 1 to 5 was irradiated with 4200 mJ/cm² of ultraviolet, an electrical measuring machine (model number: 6254; made by TOYO) was used to measure the liquid crystal display element to obtain an ion density. The measurement conditions include the application of a voltage of 1.7 V and a triangle wave of 0.01 Hz, and the calculation of peak area in the range of 0 V to 1 V in a current-voltage waveform to measure ion density (unit: pC/cm²).

: ion density<40

⊚: 40≦ion density<50

◯: 50≦ion density<100

Δ: 100≦ion density<200

X: ion density≧200

### Comparative Example 6

The liquid crystal alignment agent of comparative example 6 was prepared with the same method as example 1 except 1-octadecoxy-2,4-diaminobenzene was used to substitute b-1-1 of synthesis example 1. However, the obtained liquid crystal alignment agent cannot perform alignment after polarized ultraviolet irradiation.

### Comparative Example 7

The liquid crystal alignment agent of comparative example 7 was prepared with the same method as example 1 except formula (IV-1-2) was used to substitute b-1-1 of synthesis example 1. However, the obtained liquid crystal alignment agent cannot perform alignment after polarized ultraviolet irradiation.

TABLE 2

| | | Example | | | | | | | | |
|---|---|---|---|---|---|---|---|---|---|---|
| Component (unit: parts by weight) | | 1 | 2 | 3 | 4 | 5 | 6 | 7 | 8 | 9 |
| Polymer | A-1-1 | 100 | | | | | | | | |
| composition(A) | A-1-2 | | 100 | | | | | | | |
| | A-1-3 | | | 100 | | | | | | |
| | A-1-4 | | | | 100 | | | | | |
| | A-1-5 | | | | | 100 | | | | |
| | A-1-6 | | | | | | 100 | | | |
| | A-1-7 | | | | | | | 100 | | |
| | A-1-8 | | | | | | | | 100 | |
| | A-1-9 | | | | | | | | | 100 |
| | A-1-10 | | | | | | | | | |
| | A-1-11 | | | | | | | | | |
| | A-1-12 | | | | | | | | | |
| | A-2-1 | | | | | | | | | |
| | A-2-2 | | | | | | | | | |
| | A-2-3 | | | | | | | | | |
| | A-2-4 | | | | | | | | | |
| | A-2-5 | | | | | | | | | |
| Photopolymerizable | B-1 | 10 | | | | | 30 | 10 | | |
| compound (B) | B-2 | | 5 | | | | | 5 | | |
| | B-3 | | | 12 | | | | | | |
| | B-4 | | | | 15 | | | | | 2 |
| | B-5 | | | | | 20 | | | 8 | |
| | B-6 | | | | | 5 | | | | 20 |
| Solvent (C) | C-1 | 1200 | | 800 | 700 | | 1000 | 900 | 850 | 1400 |
| | C-2 | 600 | 1600 | | 700 | 1500 | | 300 | 850 | |
| | C-3 | | | 1000 | | 100 | | 300 | | |
| | C-4 | | | | | | 600 | | | |
| additive (D) | D-1 | | | | | | | | | 5 |
| | D-2 | | | | | 10 | | | | |
| Evaluation results | Ion density | ◯ | ◯ | ⊚ | | ⊚ | ◯ | ◯ | | ⊚ |
| | | Example | | | | Comparative example | | | | |
| Component (unit: parts by weight) | | 10 | 11 | 12 | 13 | 1 | 2 | 3 | 4 | 5 |
| Polymer | A-1-1 | | | | 50 | 100 | | | | |
| composition(A) | A-1-2 | | | | | | | | | |
| | A-1-3 | | | | | | | | | |
| | A-1-4 | | | | | | | | | |
| | A-1-5 | 50 | | | | | | | | |
| | A-1-6 | | | | | | | | | |
| | A-1-7 | | | | | | | | | |
| | A-1-8 | | | | | | | | | |
| | A-1-9 | | | | | | | | | |
| | A-1-10 | 50 | | | | | | | | |
| | A-1-11 | | | | | | 100 | | | |
| | A-1-12 | | | | | | | 100 | | |
| | A-2-1 | | 100 | | | | | | | |
| | A-2-2 | | | 100 | | | | | | |
| | A-2-3 | | | | 50 | | | | | |
| | A-2-4 | | | | | | | | 100 | |
| | A-2-5 | | | | | | | | | 100 |
| Photopolymerizable | B-1 | | 3 | | 3 | | | | 10 | |
| compound (B) | B-2 | 4 | 3 | | | | 5 | | 5 | |
| | B-3 | 10 | | 20 | | | | | | 20 |
| | B-4 | | | | | | | | | |
| | B-5 | | | | | | | | | |
| | B-6 | | | | 25 | | | | | |
| Solvent (C) | C-1 | | | | | 1200 | | | 900 | |
| | C-2 | 950 | 600 | 800 | | 600 | 1600 | 1500 | 300 | 800 |
| | C-3 | | 450 | 600 | 1500 | | | 100 | 300 | 600 |
| | C-4 | 600 | 450 | | | | | | | |
| additive (D) | D-1 | | | | 2 | | | | | |
| | D-2 | | | | 3 | | | 10 | | |
| Evaluation results | Ion density | ⊚ | ◯ | ⊚ | | X | X | X | X | X |

It can be known from Table 2 that, in comparison to the liquid crystal alignment agents (comparative examples 1 to 5) without the diamine compound (b-1) or the photopolymerizable compound (B), the ion density of the liquid crystal display elements fabricated by using the liquid crystal alignment agents (examples 1 to 13) containing both the diamine compound (b-1) and the photopolymerizable compound (B) measured after ultraviolet irradiation is smaller.

Moreover, the ion density of the liquid crystal display elements fabricated by using the liquid crystal alignment agents (examples 3 to 5, 8 to 10, and 12 to 13) using the photopolymerizable compound (B) containing the compounds represented by formula (1-31) to formula (1-42) measured after ultraviolet irradiation is even smaller.

Moreover, when the liquid crystal alignment agent contains the other diamine compounds (b-2) represented by formula (IV-1), formula (IV-2), formula (IV-8), or formula (IV-26) to formula (IV-30), the ion density of the fabricated liquid crystal display element measured after ultraviolet irradiation is particularly small.

Based on the above, since the liquid crystal alignment agent of the invention contains a specific diamine compound and photopolymerizable compound, by using the liquid crystal display element made from the liquid crystal alignment agent, the known issue of excessive ion density after ultraviolet irradiation can be alleviated. As a result, the liquid crystal alignment agent of the invention is suitable for a liquid crystal alignment film and a liquid crystal display element.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A liquid crystal alignment agent, comprising:
a polymer composition (A) obtained by reacting a mixture comprising a tetracarboxylic dianhydride component (a) and a diamine component (b);
a photopolymerizable compound (B) represented by formula (1); and
a solvent (C), 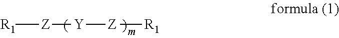
in formula (1), R₁ independently represents a polymerizable functional group represented by formula (1-1) to formula (1-5), a hydrogen atom, a halogen atom, —CN, —CF₃, —CF₂H, —CFH₂, —OCF₃, —OCF₂H, —N═C═O, —N═C—S, or a C₁ to C₂₀ alkyl group, wherein any —CH₂— in the alkyl group can be substituted by —O—, —S—, —SO₂—, —CO—, —COO—, —OCO—, —CH═CH—, —CF═CF—, or —C≡C—, and in the hydrogen atom-containing functional group, a hydrogen atom can be substituted by a halogen atom or —CN; at least one R₁ is a polymerizable functional group represented by formula (1-1) to formula (1-5); Y independently represents a divalent group of a C₃ to C₂₁ saturated or unsaturated independent ring, condensed ring, or spiro ring, wherein in the ring, any —CH₂— can be substituted by —O—, any —CH═ can be substituted by —N═, any —H can be substituted by a halogen atom, —CN, —NO₂, —NC, —N═C═O, —N═C═S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group, and in the alkyl group, any —CH₂— can be substituted by —O—, —CO—, —COO—, —OCO—, —OCOO—, —CH═CH—, or —C≡C—; Z independently represents a single bond or a C₁ to C₂₀ alkylene group, wherein in the alkylene group, any —CH₂— can be substituted by —O—, —S—, —SO₂—, —CO—, —COO—, —OCO—, —OCOO—, —CH═CH—, —CF═CF—, —CH═N—, —N═N—, —N(O)═N—, or —C≡C—, and any —H can be substituted by a halogen atom, a C₁ to C₁₀ alkyl group, or a C₁ to C₁₀ haloalkyl group; m represents an integer of 1 to 6, and when m is an integer of 2 to 6, a plurality of —Y—Z— can be the same or different; 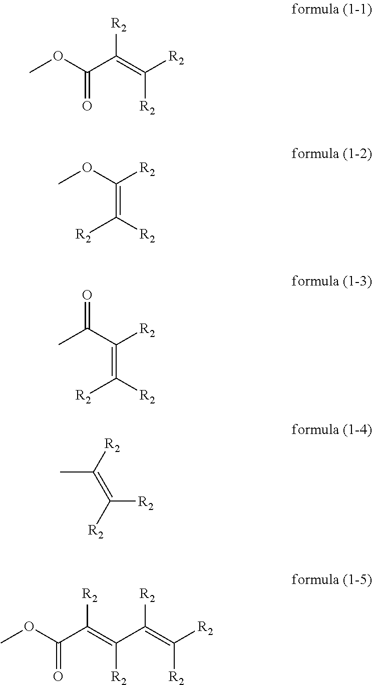
in formula (1-1) to formula (1-5), R₂ represents a hydrogen atom, a halogen atom, —CF₃, or a C₁ to C₅ alkyl group;
wherein the diamine component (b) comprises at least one diamine compound (b-1) having a structure represented by formula (II); 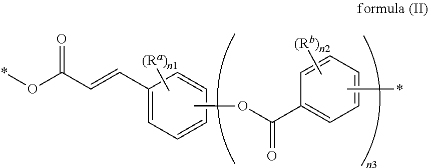
in formula (II), R^{a} and R^{b} each independently represent a C₁ to C₆ alkyl group, a C₁ to C₆ alkoxy group, a halogen atom, or a cyano group; n1 and n2 each independently represent an integer of 0 to 4; n3 represents 0 or 1; and * each independently represents a connecting bond.

2. The liquid crystal alignment agent of claim 1, wherein at least one R₁ is a polymerizable functional group represented by formula (1-1) to formula (1-3).

3. The liquid crystal alignment agent of claim 1, wherein Y each independently represents a divalent group of 1,4-cyclohexylene, 1,4-cyclohexenylene, 1,4-phenylene, naphthalene-2,6-diyl, tetrahydronaphthalene-2,6-diyl, fluorene-2,7-diyl, bicyclo[2.2.2]octane-1,4-diyl, bicyclo[3.1.0]hexane-3,6-diyl, or triptycene-1,4-diyl, wherein in the ring, any —CH₂— can be substituted by —O—, any —CH═ can be substituted by —N═, any —H can be substituted by a halogen atom, —CN, —NO₂, —NC, —N═C═O, —N═C═S, a silyl group substituted by 1 to 3 of C₁ to C₄ alkyl groups or phenyl groups, a C₁ to C₁₀ straight-chain alkyl group, a C₁ to C₁₀ branched-chain alkyl group, or a C₁ to C₁₀ haloalkyl group, and in the alkyl group, any —CH₂— can be substituted by —O—, —CO—, —COO—, —OCO—, —OCOO—, —CH═CH—, or —C≡C—.

4. The liquid crystal alignment agent of claim 1, wherein Y is at least one group selected from the group consisting of functional groups represented by formula (1-6) to formula (1-30): 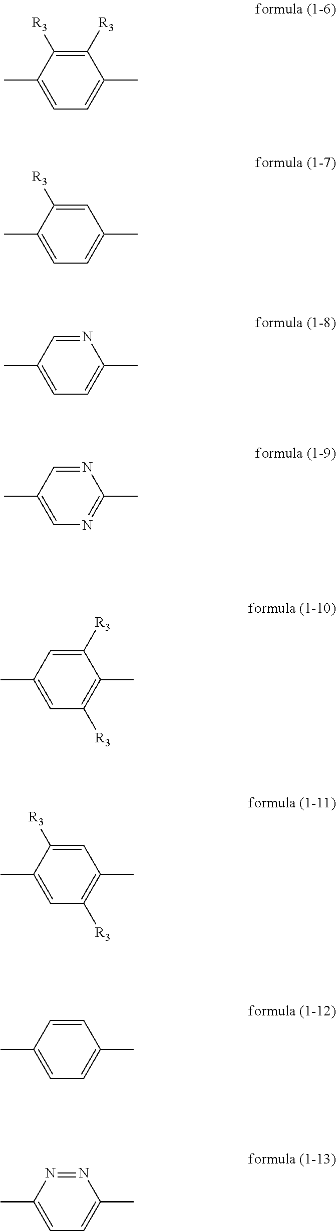 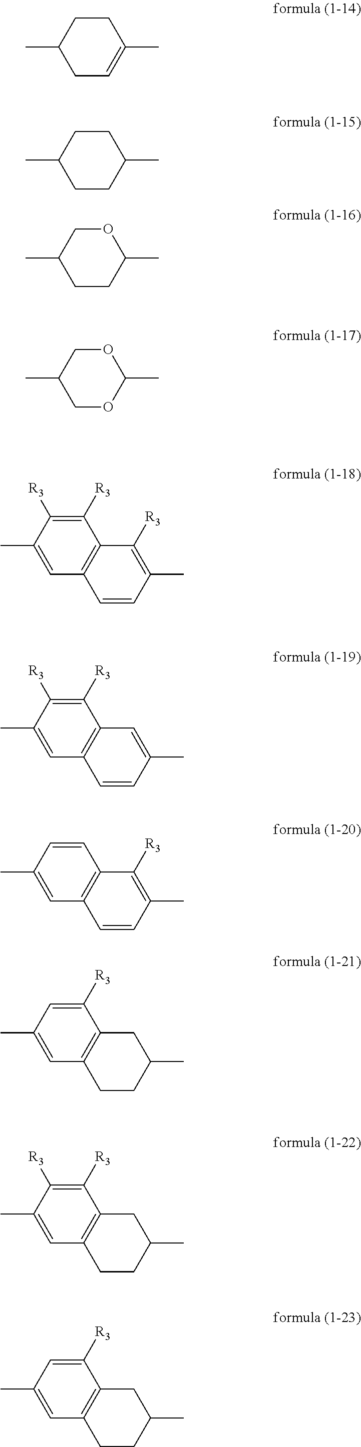 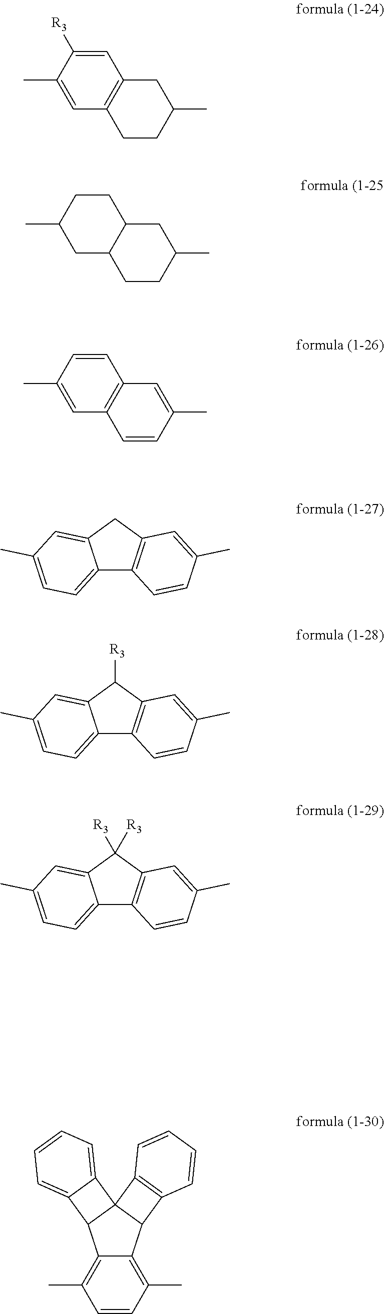
in formula (1-6) to formula (1-30), R₃ represents a halogen atom, a C₁ to C₃ alkyl group, a C₁ to C₃ alkoxy group, or a C₁ to C₃ haloalkyl group.

5. The liquid crystal alignment agent of claim 1, wherein the photopolymerizable compound (B) is at least one compound selected from the group consisting of compounds represented by formula (1-31) to formula (1-42): 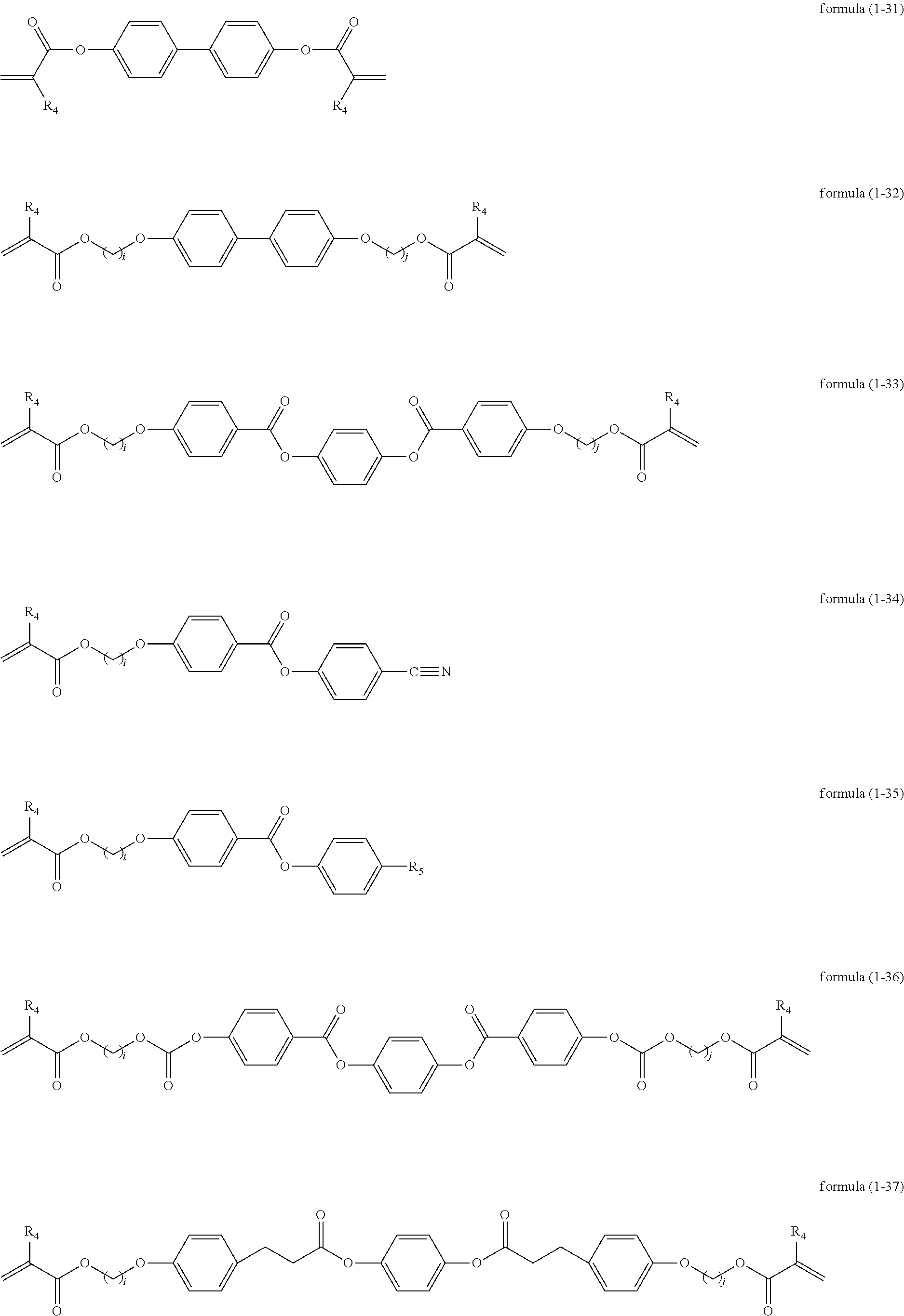 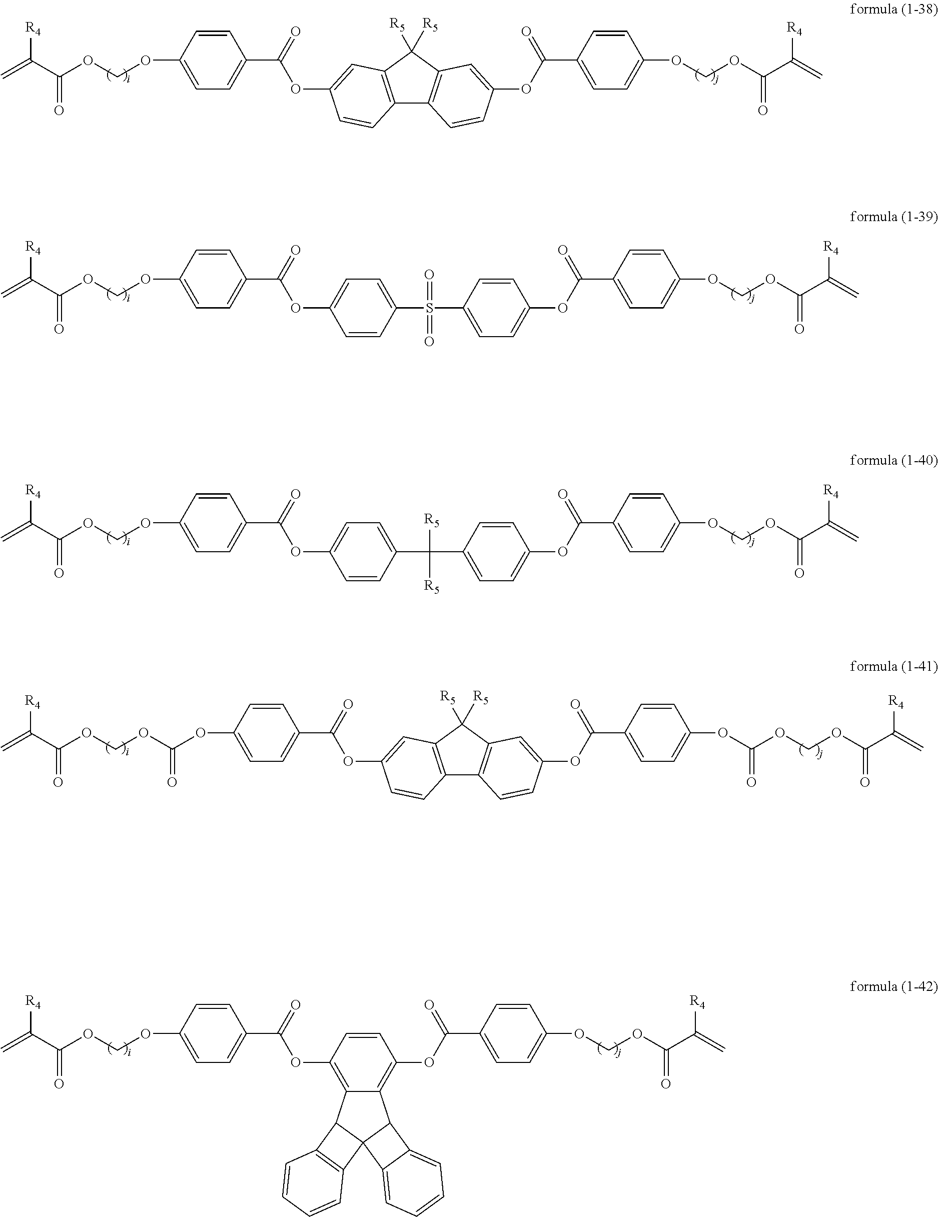
in formula (1-31) to formula (1-42), R₄ independently represents a hydrogen atom or a methyl group; R₅ independently represents a hydrogen atom, a halogen atom, a methyl group, —CF₃, —OCH₃, or a phenyl group, and 2 R₅ on a same carbon atom can form a C₆ to C₁₅ saturated or unsaturated hydrocarbon ring; and i and j independently represent an integer of 1 to 20.

6. The liquid crystal alignment agent of claim 1, wherein the diamine compound (b-1) has at least one structure selected from the group consisting of a structure represented by formula (II-1) and a structure represented by formula (II-2); 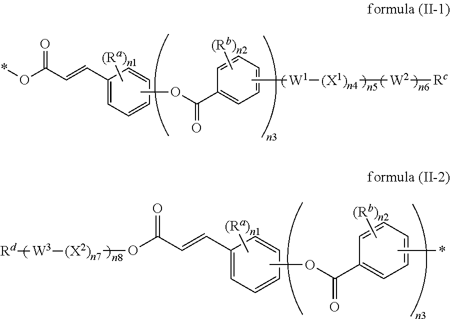
in formula (II-1) and formula (II-2), R^{a} and R^{b} each independently represent a C₁ to C₆ alkyl group, a C₁ to C₆ alkoxy group, a halogen atom, or a cyano group; R^{c} and R^{d} each independently represent a C₁ to C₄₀ alkyl group or a fluorine atom-substituted C₁ to C₄₀ alkyl group; W¹, W², and W³ each independently represent —O—, —CO—, —CO—O—, —O—CO—, —NR^{e}—, —NR^{e}—CO—, —CO—NR^{e}—, —NR^{e}—CO—O—, —O—CO—NR^{e}—, —NR^{e}—CO—NR^{e}—, or —O—CO—O—, wherein R^{e} represents a hydrogen atom or a C₁ to C₄ alkyl group; X¹ and X² each independently represent a methylene group, an arylene group, a divalent alicyclic group, —Si(CH₃)₂—, —CH═CH—, —C≡C—, a methylene group having a substituent, an arylene group having a substituent, a divalent alicyclic group having a substituent, —Si(CH₃)₂— having a substituent, or —CH═CH— having a substituent, wherein the substituent is a cyano group, a halogen atom, or a C₁ to C₄ alkyl group; n1 and n2 each independently represent an integer of 0 to 4; n3 represents 0 or 1; n4 and n7 each independently represent an integer of 1 to 6; n5 and n8 each independently represent an integer of 0 to 2; n6 represents 0 or 1; and * each independently represents a connecting bond.

7. The liquid crystal alignment agent of claim 1, wherein based on a total usage amount of 100 moles of the diamine component (b), a usage amount of the diamine compound (b-1) is 10 moles to 80 moles.

8. The liquid crystal alignment agent of claim 1, wherein based on a usage amount of 100 parts by weight of the photopolymerizable compound (A), a usage amount of the photopolymerizable compound (B) is 5 parts by weight to 30 parts by weight.

9. A liquid crystal alignment film formed by the liquid crystal alignment agent of claim 1.

10. A liquid crystal display element, comprising the liquid crystal alignment film of claim 9.
